(19) United States
(12) Patent Application Publication
(10) Pub. No.: US 2021/0224913 A1
(43) Pub. Date: Jul. 22, 2021

(54) DISPLAYING WELL DATA AND COMPARING PROSPECT AND EXISTING WELLS

(71) Applicant: Oilwellstore.com, LLC, Fort Worth, TX (US)

(72) Inventor: Thomas E. Tapia, Fort Worth, TX (US)

(21) Appl. No.: 17/150,212

(22) Filed: Jan. 15, 2021

Related U.S. Application Data
(60) Provisional application No. 62/961,979, filed on Jan. 16, 2020.

(51) Int. Cl. G06Q 40/06; E21B 47/26; E21B 47/12; G06Q 40/02

(52) U.S. Cl. CPC G06Q 40/06; G06Q 40/02; E21B 47/12; E21B 47/26

(57) ABSTRACT

A method includes comparing and displaying prospect and existing well data on a graphical user interface. The method includes displaying a close-ology map portion that provides a visual indicator of existing well locations relative to a prospect well. The system displays the close-ology map portion along with all other partnership details on a partnership details page. All relevant information is displayed or accessible via the partnership details page. Data relating to the existing well locations is accessed and displayed to a user of the graphical user interface and can be filtered and compared easily to the prospect well.

### CROSS-REFERENCE TO RELATED APPLICATION

This application claims the benefit of the filing date of, and priority to, U.S. Application No. 62/961,979, filed Jan. 16, 2020 bearing Attorney Docket No. 59504.3PV01, the entire disclosure of which is hereby incorporated herein by reference.

### BACKGROUND

The present disclosure relates in general to displaying well day and comparing prospect and existing wells.

### BRIEF DESCRIPTION OF THE DRAWINGS

FIG. 1 is a diagrammatic illustration of a system according to an example embodiment, the system including a computer comprising a graphical user interface (“GUI”) that is configured to display a plurality of windows.

FIG. 2 is a flow chart illustration of a method of operating the system of FIG. 1, according to an example embodiment.

FIGS. 3-43 are illustrations of windows displayed on the GUI of the computer of FIG. 1, according to an example embodiment.

FIGS. 44a and 44b together form an illustration of a window displayed on the GUI of the computer of FIG. 1, according to an example embodiment.

FIGS. 45-48 are illustrations of windows displayed on the GUI of the computer of FIG. 1, according to an example embodiment.

FIG. 49 is a diagrammatic illustration of a computing device, or node, for implementing one or more example embodiments of the present disclosure, according to an example embodiment.

### DETAILED DESCRIPTION

The following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

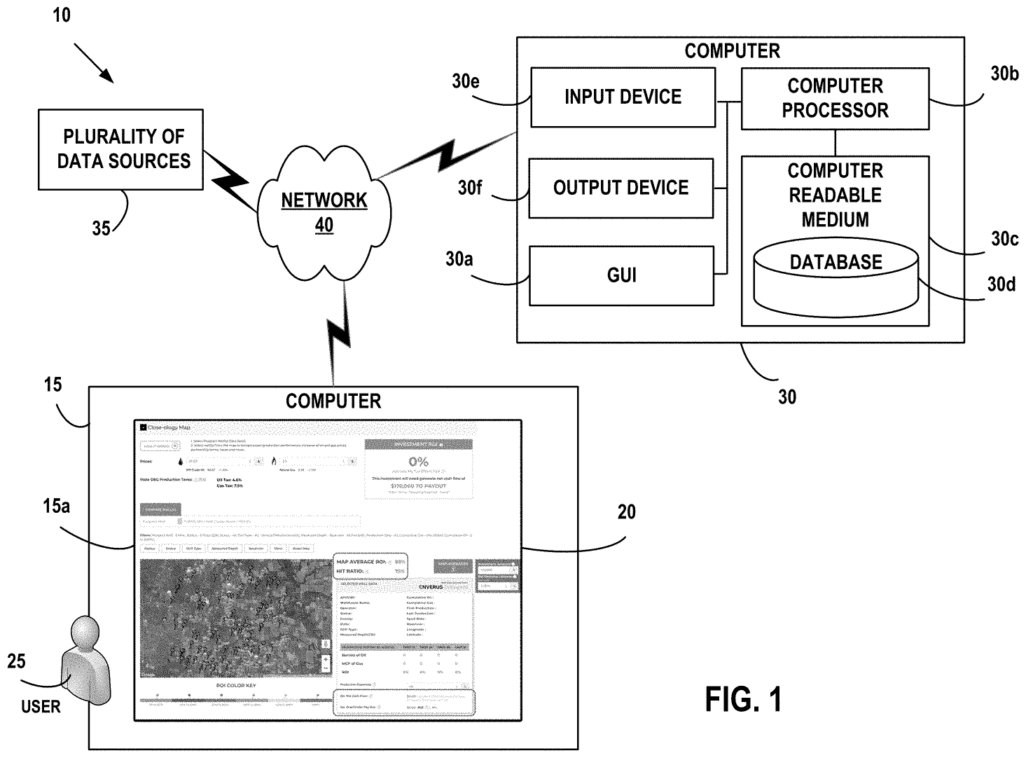

In an example embodiment, as illustrated in FIG. 1, a system is generally referred to by the reference numeral 10 and includes a computer 15 that includes a graphical user display (“GUI”) 15a capable of displaying a window or window 20 to a user 25 of system 10; a computer 30, and a plurality of data sources 35, all of which are operably connected via a network 40.

In an example embodiment, the computer 30 includes a GUI 30a, a computer processor 30b and a computer readable medium 30c operably coupled thereto. Instructions accessible to, and executable by, the computer processor 30b are stored on the computer readable medium 30c. A database 30d is also stored in the computer readable medium 30c. Generally, the GUI 30a can display a plurality of windows to the user. The computer 30 also includes an input device 30e and an output device 30f. In some embodiments, the input device 30e and the output device 30f are the GUI 30a. In some embodiments, the user provides inputs to the system 10 via a window that is displayed on the GUI 30a. However, the input device 30e can also be a microphone in some embodiments and the output device 30f is a speaker. In several example embodiments, the computer 30 is, or includes, a telephone, a personal computer, a personal digital assistant, a cellular telephone or mobile phone, other types of telecommunications devices, other types of computing devices, and/or any combination thereof. In several example embodiments, the computer 30 includes a plurality of remote user devices. In one or more example embodiments, the computer 30 includes or is operably coupled to an application or an application server, which in several example embodiments includes and/or executes one or more web-based programs, Intranet-based programs, and/or any combination thereof. In an example embodiment, the application includes a computer program including a plurality of instructions, data, and/or any combination thereof. In an example embodiment, the application is written in, for example, Hypertext Markup Language (HTML), Cascading Style Sheets (CSS), JavaScript, Extensible Markup Language (XML), asynchronous JavaScript and XML (Ajax), and/or any combination thereof. In an example embodiment, the application is a web-based application written in, for example, Java or Adobe Flex, which pulls real-time information from another computer and/or the plurality of data sources 35. In an example embodiment, the application pulls real-time information from the plurality of data sources 35, upon the execution, opening or start-up of the application. In an example embodiment, the application is stored on the computer readable medium 30c and/or in the database 30d. In an example embodiment, the computer 30 may include a specially designed code, such as for example SAS code and/or UNIX. In an example embodiment, the SAS code allows communication with an external database, such as a database associated with one or more of the plurality of data sources 35.

In some embodiments, the computer 15 is identical or similar to the computer 30 in that the computer 15 also includes the GUI 15a, a computer processor and a computer readable medium operably coupled thereto. Instructions accessible to, and executable by, the computer processor are stored on the computer readable medium. A database is also stored in the computer readable medium. Generally, the GUI 15a can display a plurality of windows or windows to the user 25. The computer 15 also includes an input device and an output device. In some embodiments, the input device and the output device are the GUI 15a. In some embodiments, the user 25 provides inputs to the system 10 via a window that is displayed on the GUI 15a. However, the input device can also be a microphone in some embodiments and the output device is a speaker. In several example embodiments, the computer 15 is, or includes, a telephone, a personal computer, a personal digital assistant, a cellular telephone or mobile phone, other types of telecommunications devices, other types of computing devices, and/or any combination thereof.

In some embodiments, the plurality of data sources 35 includes data sources that include data relating to well data that includes geographical location of each well; data relating to oil and gas prices; and tax data, among other data.

In an example embodiment, the network 40 includes the Internet, one or more local area networks, one or more wide area networks, one or more cellular networks, one or more wireless networks, one or more voice networks, one or more data networks, one or more communication systems, and/or any combination thereof. In some embodiments, the network 40 also includes WIFI, Bluetooth, and Long-Term Evolution (“LTE”) or other wireless broadband communication technology.

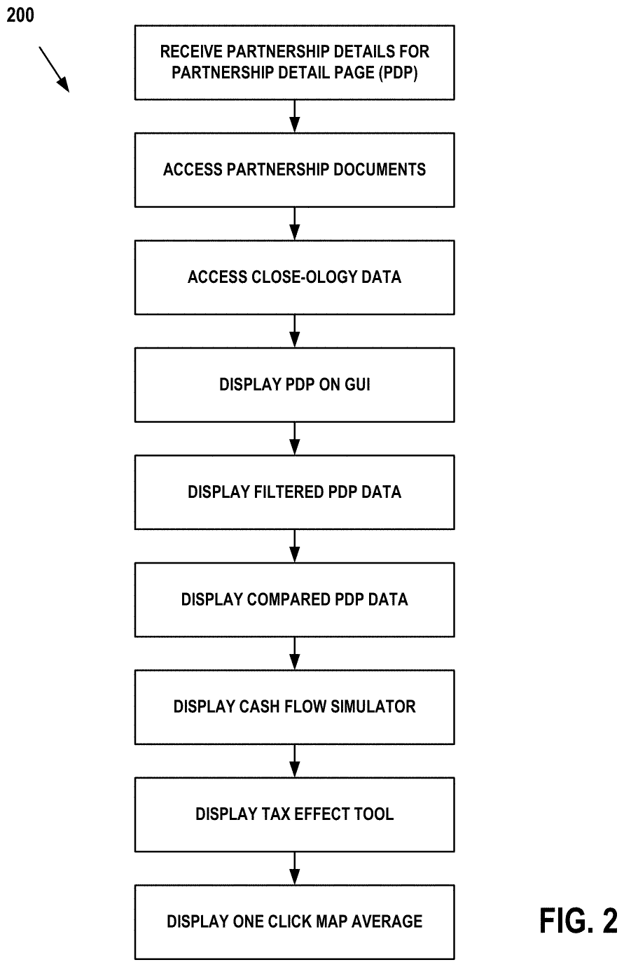

In an example embodiment, as illustrated in FIG. 2 with continuing reference to FIG. 1, a method of operating the system 10 includes receiving partnership details for the partnership detail page (“PDP”); accessing partnership documents; accessing close-ology data; displaying PDP data on the GUI; displaying filtered PDP data; displaying compared PDP data; displaying a cash flow simulator; displaying a tax effect tool; and displaying a one click map average.

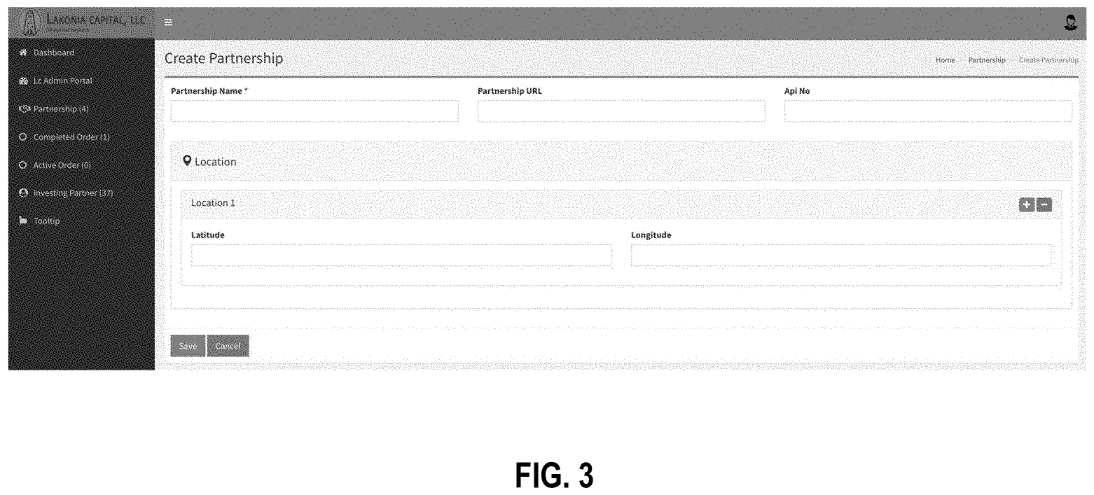

FIG. 3 is an illustration of a window displayed on the GUI 15a during the method 200. In some embodiments, FIG. 3 is an illustration of a window displayed during the step of receiving partnership details.

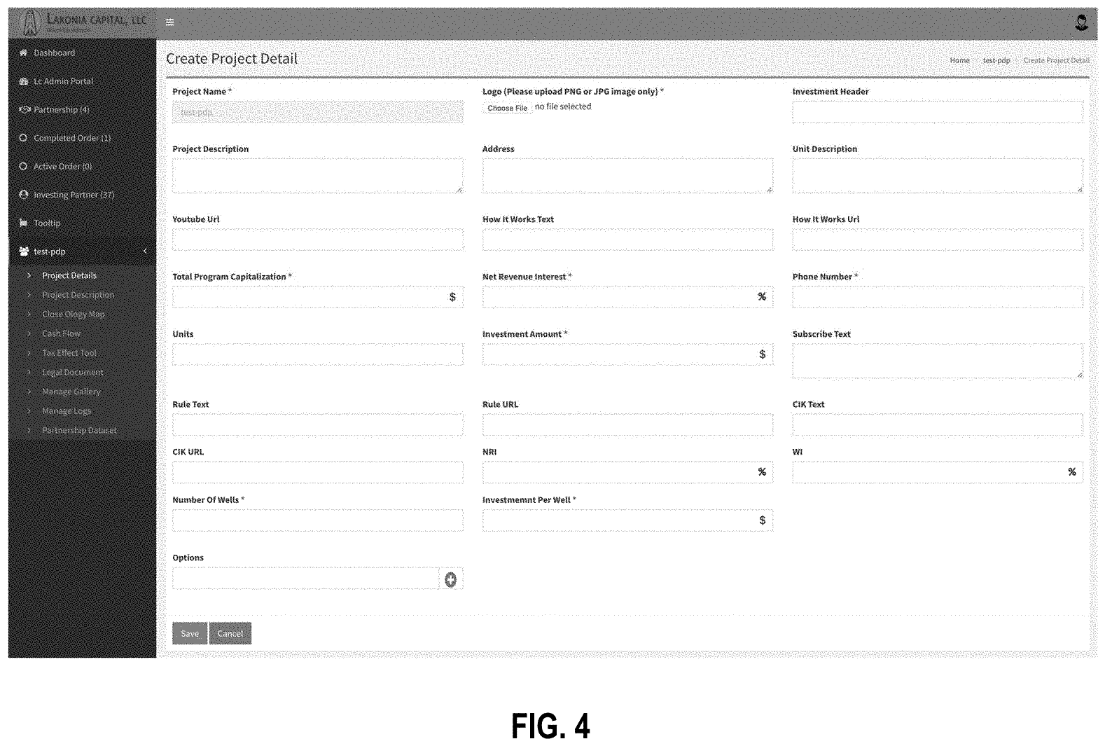

FIG. 4 is an illustration of a window displayed on the GUI 15a during the method 200. In some embodiments, FIG. 4 is an illustration of a window displayed during the step of receiving partnership details.

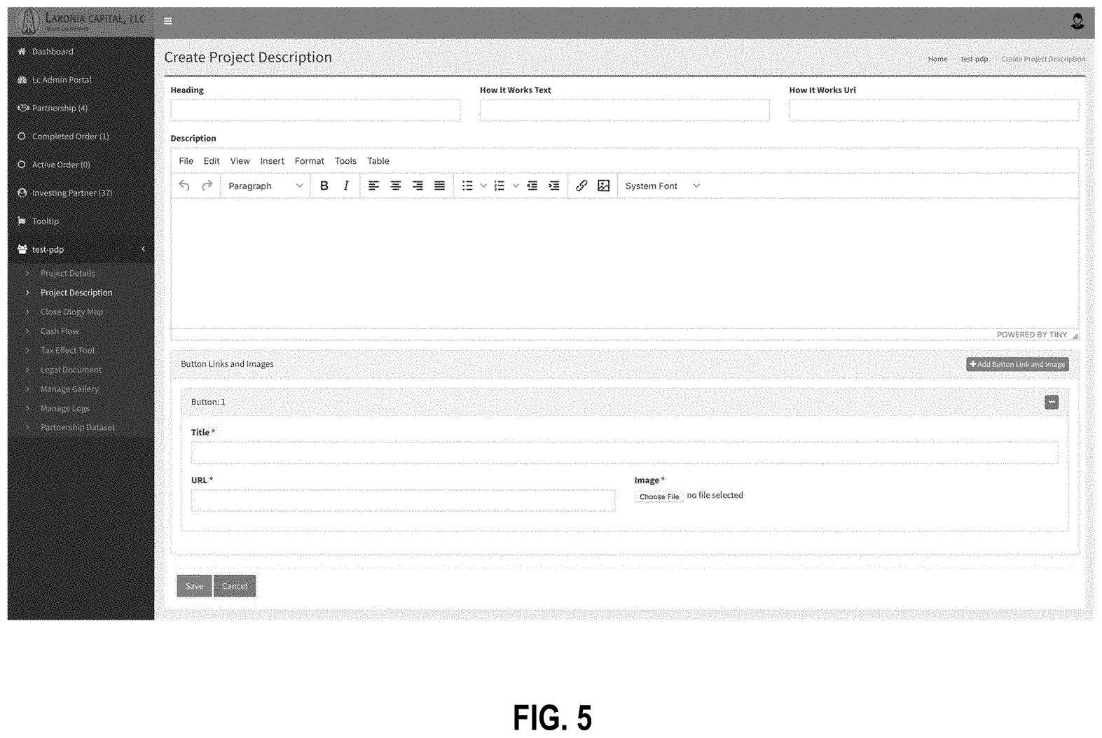

FIG. 5 is an illustration of a window displayed on the GUI 15a during the method 200. In some embodiments, FIG. 5 is an illustration of a window displayed during the step of receiving partnership details.

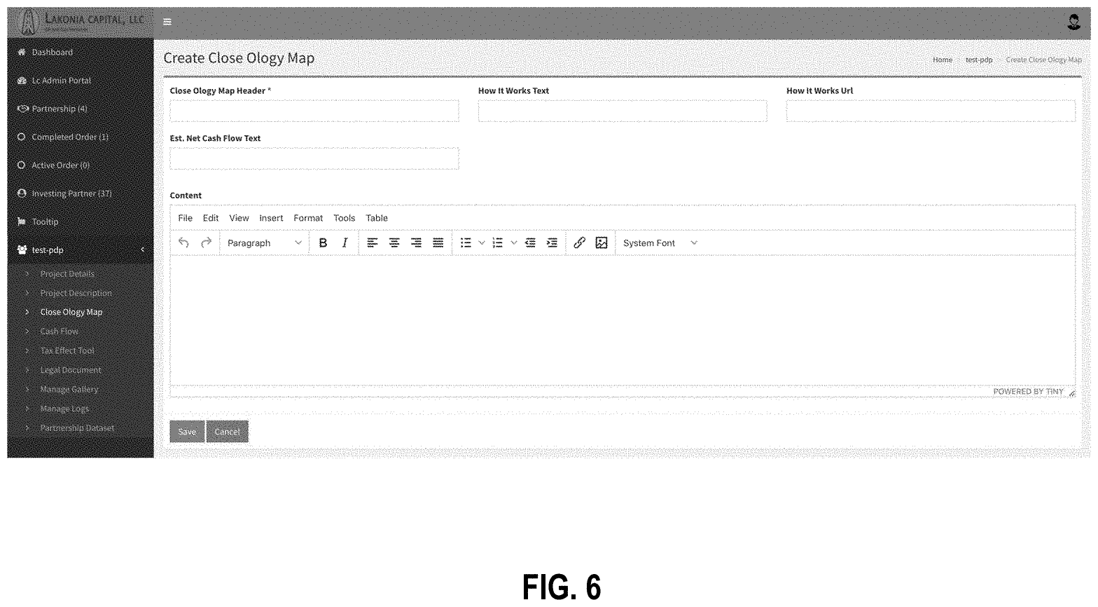

FIG. 6 is an illustration of a window displayed on the GUI 15a during the method 200. In some embodiments, FIG. 6 is an illustration of a window displayed during the step of receiving partnership details.

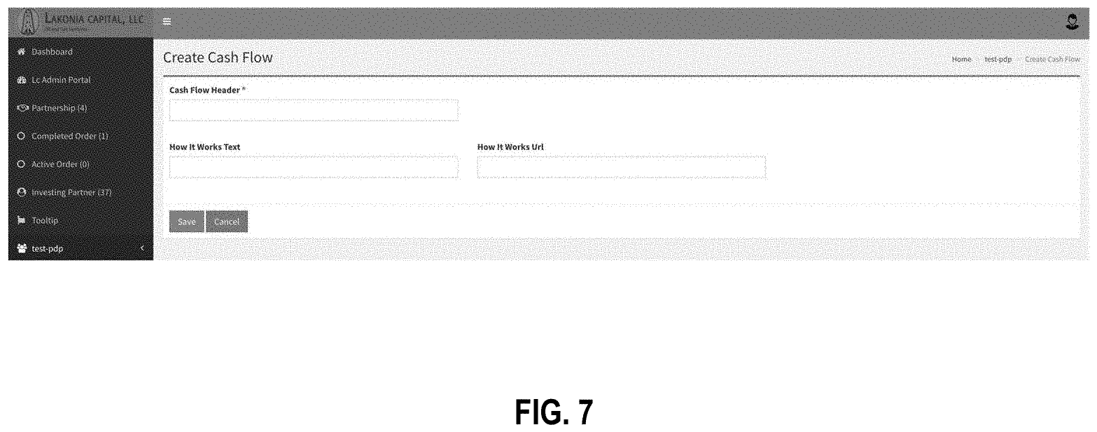

FIG. 7 is an illustration of a window displayed on the GUI 15a during the method 200. In some embodiments, FIG. 7 is an illustration of a window displayed during the step of receiving partnership details.

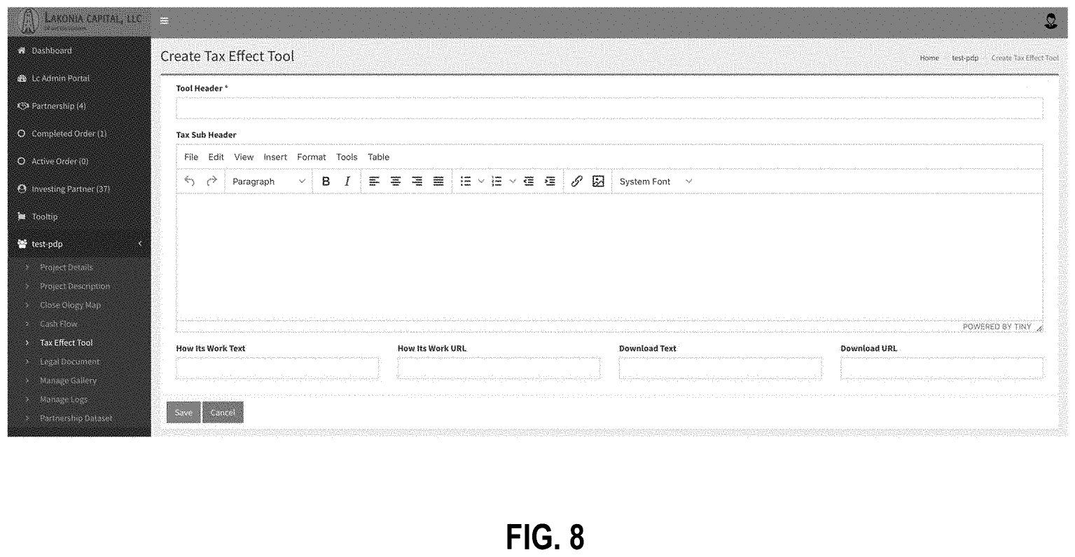

FIG. 8 is an illustration of a window displayed on the GUI 15a during the method 200. In some embodiments, FIG. 8 is an illustration of a window displayed during the step of receiving partnership details.

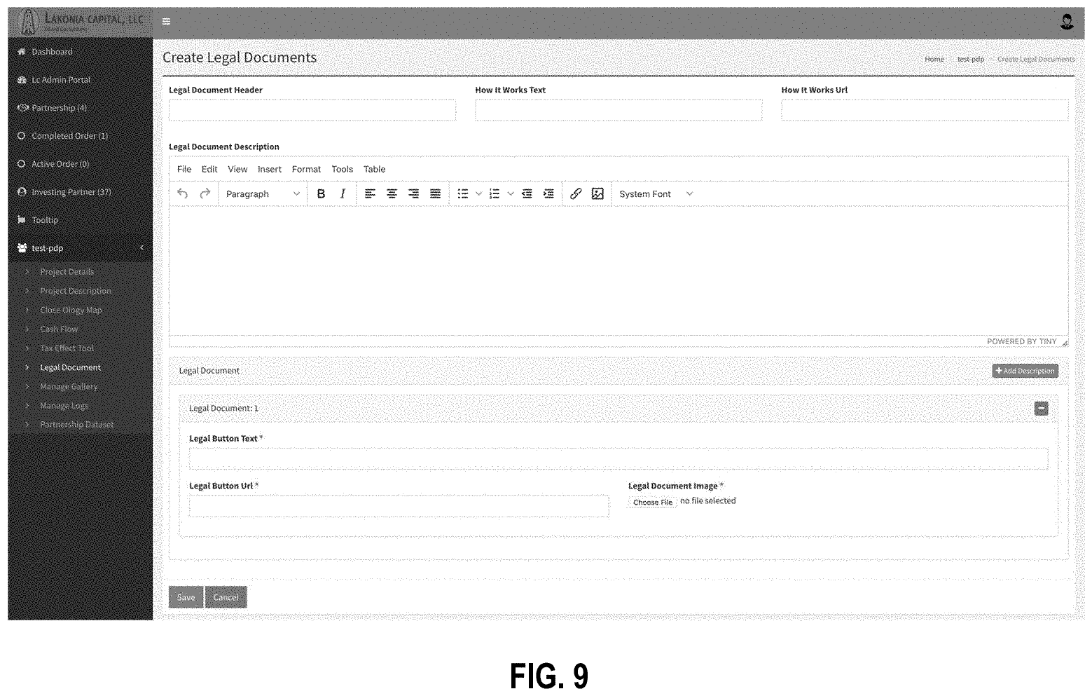

FIG. 9 is an illustration of a window displayed on the GUI 15a during the method 200. In some embodiments, FIG. 9 is an illustration of a window displayed during the step of receiving partnership details.

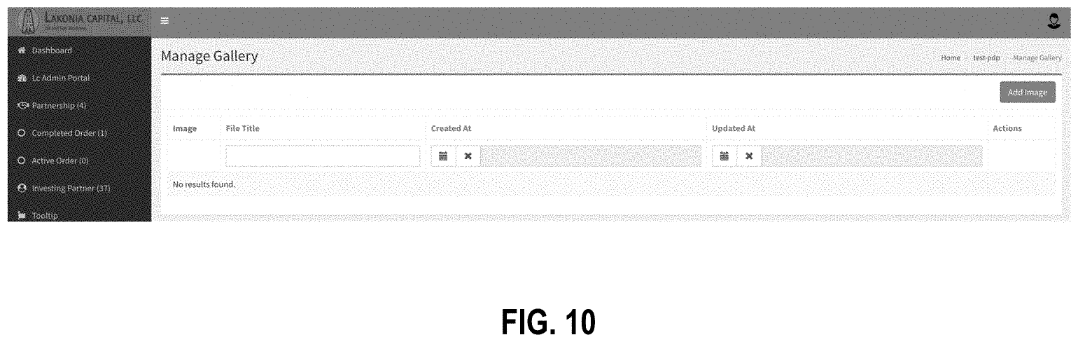

FIG. 10 is an illustration of a window displayed on the GUI 15a during the method 200. In some embodiments, FIG. 10 is an illustration of a window displayed during the step of receiving partnership details.

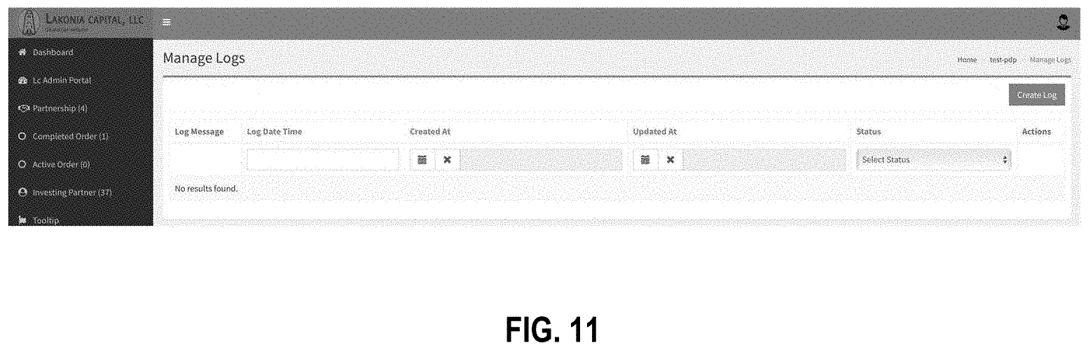

FIG. 11 is an illustration of a window displayed on the GUI 15a during the method 200. In some embodiments, FIG. 11 is an illustration of a window displayed during the step of receiving partnership details.

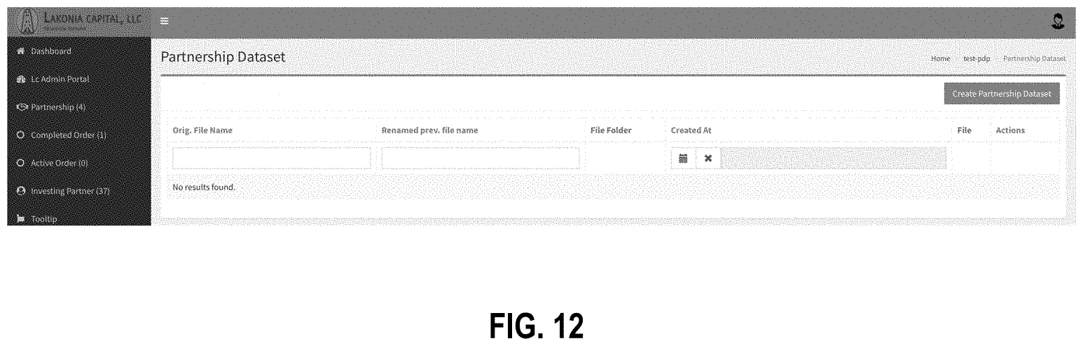

FIG. 12 is an illustration of a window displayed on the GUI 15a during the method 200. In some embodiments, FIG. 12 is an illustration of a window displayed during the step of receiving partnership details.

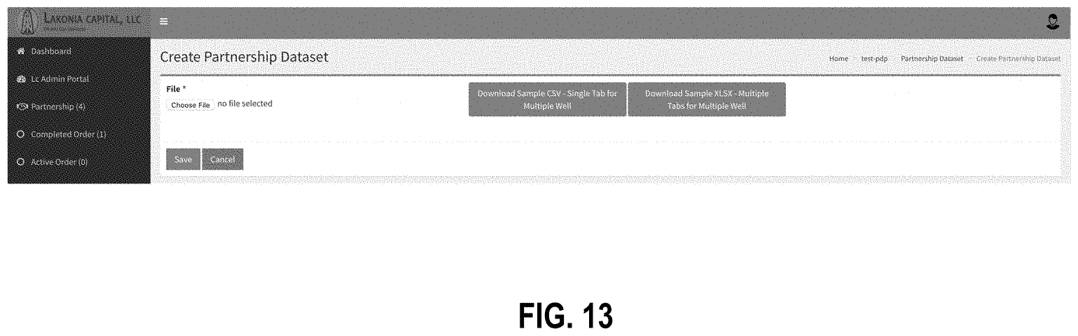

FIG. 13 is an illustration of a window displayed on the GUI 15a during the method 200. In some embodiments, FIG. 13 is an illustration of a window displayed during the step of receiving partnership details.

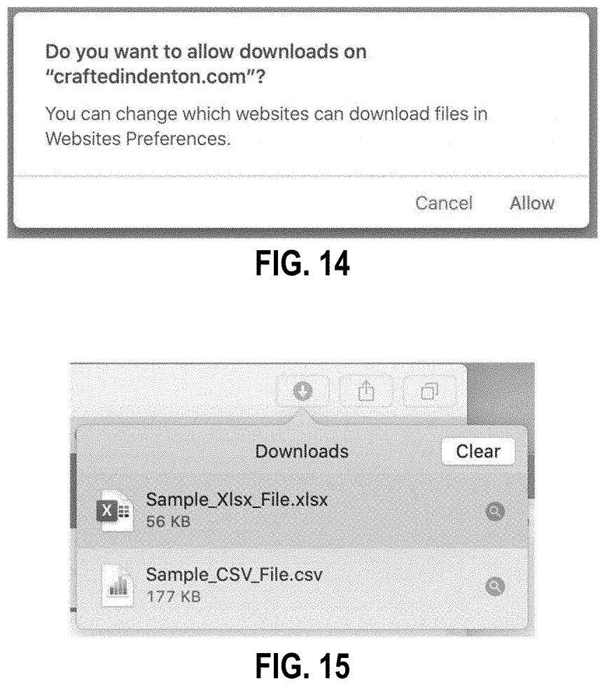

FIG. 14 is an illustration of a window displayed on the GUI 15a during the method 200. In some embodiments, FIG. 14 is an illustration of a window displayed during the step of receiving partnership details.

FIG. 15 is an illustration of a window displayed on the GUI 15a during the method 200. In some embodiments, FIG. 15 is an illustration of a window displayed during the step of receiving partnership details.

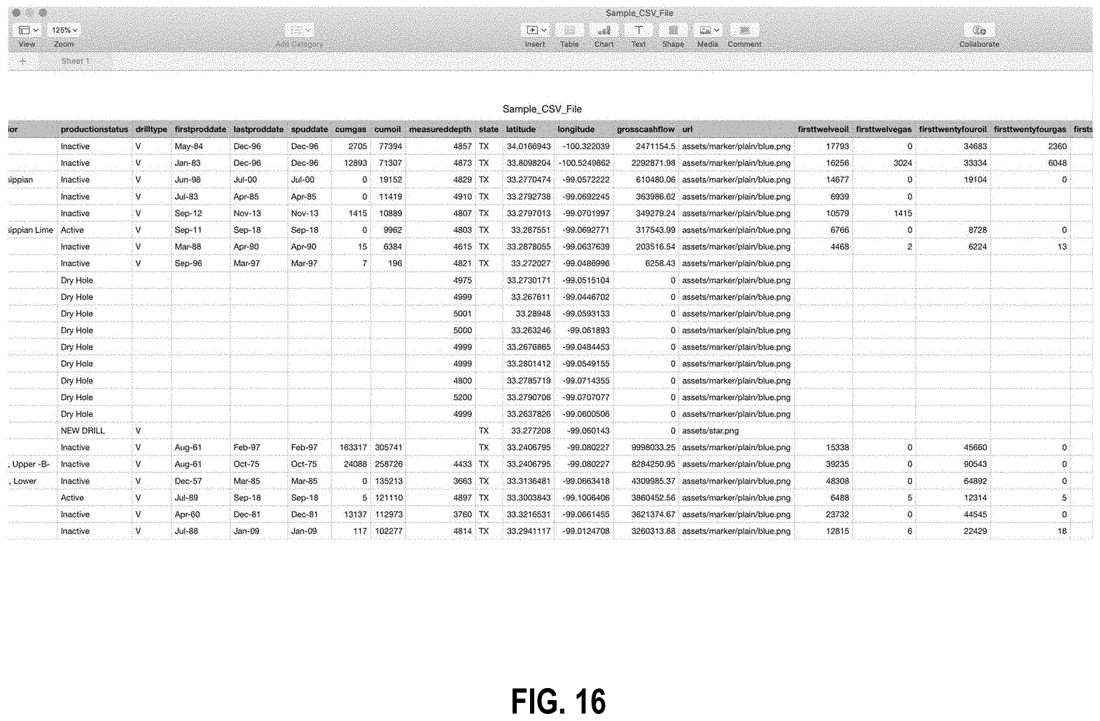

FIG. 16 is an illustration of a window displayed on the GUI 15a during the method 200. In some embodiments, FIG. 16 is an illustration of a window displayed during the step of receiving partnership details and/or accessing partnership documents.

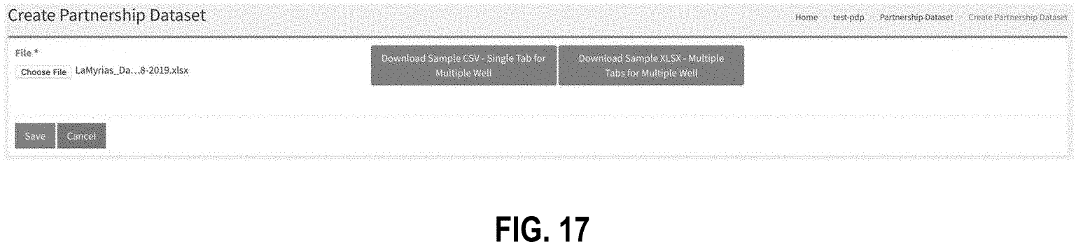

FIG. 17 is an illustration of a window displayed on the GUI 15a during the method 200. In some embodiments, FIG. 17 is an illustration of a window displayed during the step of receiving partnership details and/or accessing partnership documents.

In some embodiments, a completed partnership detail page (“PDP”) includes any one or more of the following elements or data that aids in the display of one or more of the following elements: Header: Company Logo/Project Title; Overview: Video content placeholder; Terms/Highlights; Digital Subscription Process; Subscribe Now: Video content placeholder; SEC Regulation D Rule 506(c) link; SEC Form D Filing; Phone Number/Email Contact; Project Description; Investment Amount; Net Revenue Interest; Investment ROI; Close-ology: Video content placeholder; Oil and Gas Prices; third-party web site; State Taxes: third-party link to tax rate information; Compare Well(s) bar; Filters and navigation trail; Digital Map zoom in/out with aerial, street view; Map Average ROI; Hit Ratio; One Click Map Averages; Selected Well Data—Third Party Data Provider; ROI Color Key; Production Expenses; Estimated Net Cash Flow; Estimated Over/Under Payout; Activate My Tax Effect Tool; OWS, or the application associated with the Oilwellstore.com, ROI's for combined Barrels of Oil and MCF of Gas; Tax Equivalent ROI's; and Legal Documents.

In some embodiments, the step of accessing close-ology data includes accessing data from the one or more of the plurality of data sources 35. For example, the system 10 accesses well data regarding existing wells via one or more of the data sources 35. In some embodiments, one or more of the data sources 35 is a third-party provider of data.

In some embodiments, the method includes creating a PDP that is configured to be displayed on the GUI of the computer.

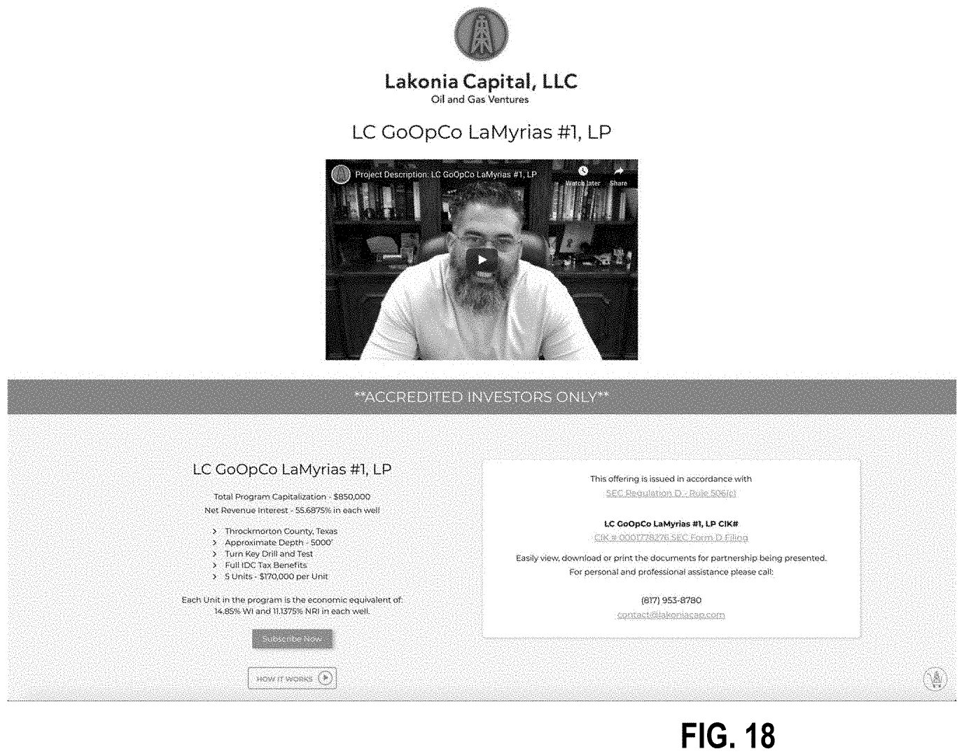

FIG. 18 is an illustration of a window displayed on the GUI 15a during the method 200 that includes a portion of the PDP. As illustrated, the portion of the PDP in FIG. 18 includes the header, which is the company logo and/or project title; an overview portion, which in some embodiments includes video content or a video content placeholder; terms and/or highlights; a digital subscription process; a “subscribe Now: video content placeholder”; a SEC Regulation D Rule 506(c) link; a SEC Form D Filing; and contact information such as a phone number or email contact.

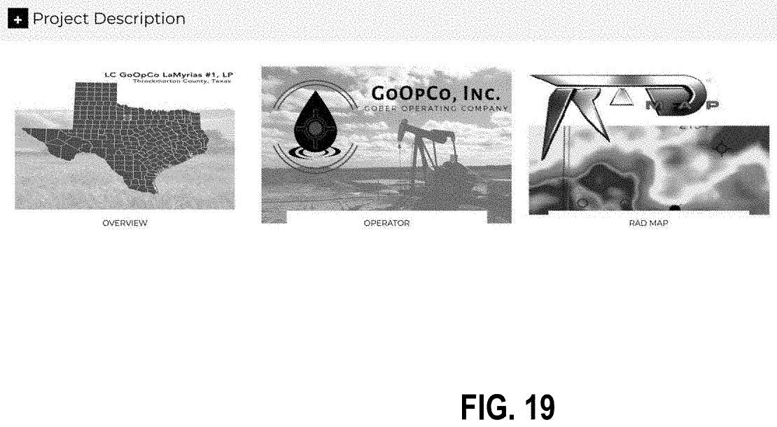

FIG. 19 is an illustration of a window displayed on the GUI 15a during the method 200 that includes a portion of the PDP. As illustrated, the portion of the PDP in FIG. 19 includes a project description, which may include space for and/or links to presentation documents, web pages, and third-party links.

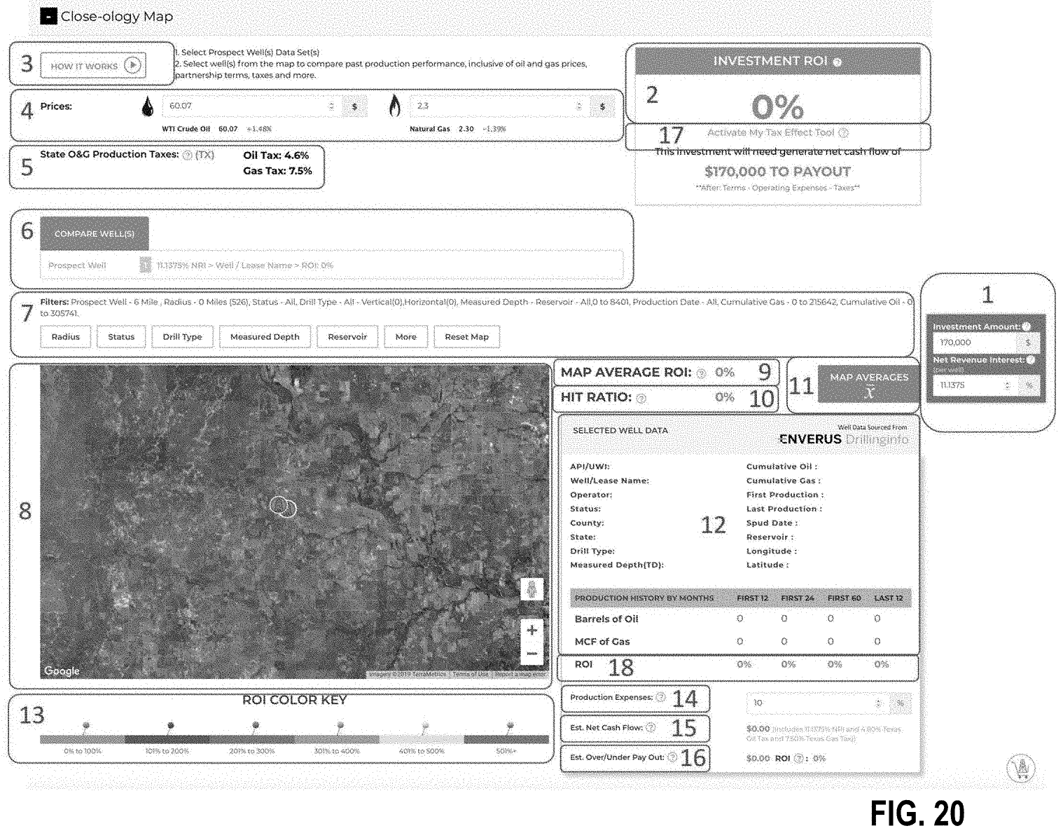

FIG. 20 is an illustration of a window displayed on the GUI 15a during the method 200 that includes a portion of the PDP. As illustrated, the portion of the PDP in FIG. 20 includes a Close-ology Map portion. In some embodiments, the Close-ology Map Elements Displayed include any one or more of: 1) Investment Amount and Net Revenue Interest; 2) Investment ROI; 3) Close-ology: Video content placeholder; 4) Oil and Gas Prices; third-party web site; 5) State Taxes: third-party link to tax rate information; 6) Compare Well(s) bar; 7) Filters and navigation trail; 8) Digital Map zoom in/out with aerial, street view; 9) Map Average ROI; 10) Hit Ratio; 11) One Click Map Averages; 12) Selected Well Data—Enverus; 13) ROI Color Key; 14) Production Expenses; 15) Estimated Net Cash Flow; 16) Estimated Over/Under Payout; 17) Activate My Tax Effect Tool; and 18) OWS ROI's for combined Barrels of Oil and MCF of Gas.

In some embodiments, the Investment ROI is represented by the following equation:

Investment ROI=(((Cumulative Oil*Oil Price)−State Taxes)+((Cumulative Gas*Gas Price)−State Taxes)*NRI %)−Production Expenses %/Hypothetical Investment Amount) (1)

Generally, the ROI, or Return on Investment, for the selected well or group of wells is expressed as a percentage. The method of calculating ROI is a proprietary method of analysis created by OWS and is activated by user inputs to describe the potential financial performance of historic well data or manually entered well data and dry holes.

In some embodiments, the Map Average ROI is an average of the ROI's for each data point in the selected, or filtered, data set. That is, the Map Average ROI includes the ROI's for each data point in the selected data set summed and divided by the number of wells in the selected data set.

In some embodiments, the Hit Ratio is represented by the following equation:

Hit Ratio=100%−dry holes/productive well reflecting inputs from “Status” filter (2)

In some embodiments, the Estimated Net Cash Flow (“ENCF”) represents the amount of total potential cash flow that could be generated if all entries remain true. In some embodiments, the ENCF formula is represented by the following equation:

ENCF=Cumulative Oil*Oil Price−State Taxes+Cumulative Gas*Your Gas Price−State Taxes*NRI %−Operating Expenses % (3)

In some embodiments, the Estimated Over/Under Payout represents in dollars, how much the total potential cash flow generated from the selected well including user inputs would exceed (over) or fall short (under) of the Investment Amount. In some embodiments, the Estimated Over/Under Payout formula is represented by the following equation:

Estimated Over/Under Payout=Estimated Net Cash Flow−Investment Amount (4)

In some embodiments, the Digital Map zoom in/out with aerial, street view includes a visual indication, such as a pin, of a geographical location of a well. In some embodiments, the pins are color-coded or otherwise distinguishable from other pins such that the pins can be grouped by ROI ranges, operators, or etc. In some embodiments, each pin is selectable, and the selection of a pin populates data relating to that well in the Selected Well Data portion of the PDP.

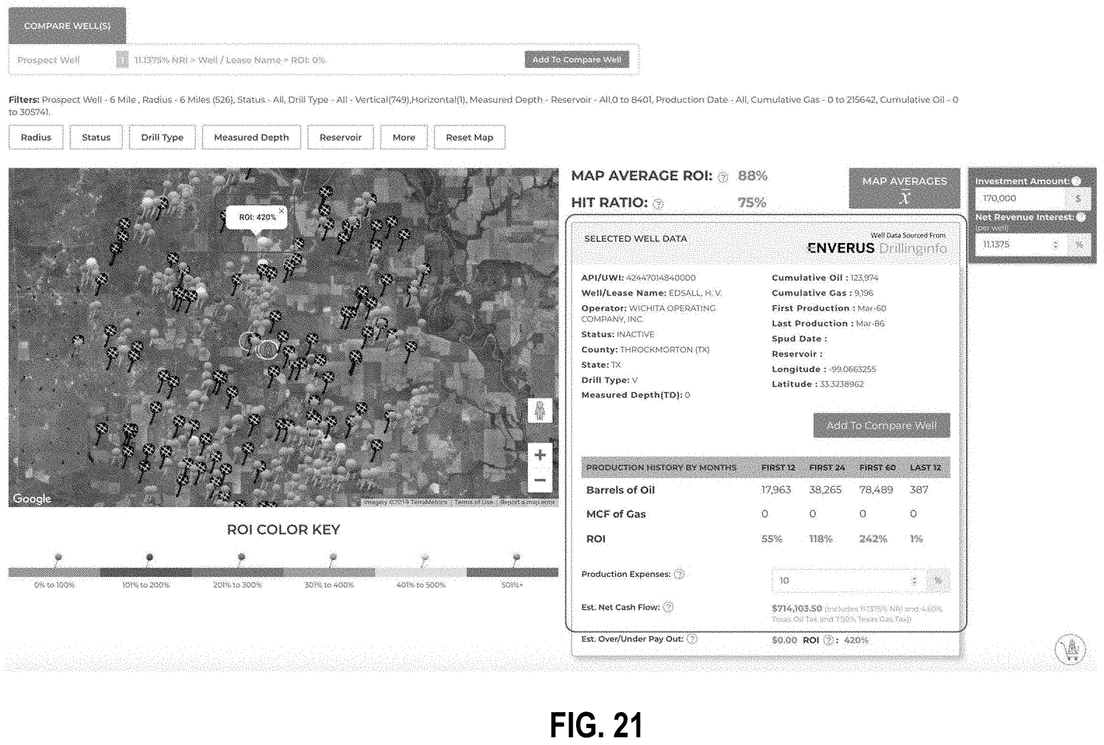

In some embodiments, the Selected Well Data portion displays data relating to a selected well (via selection for example via a pin displayed in the Digital Map portion). In some embodiments, when a pin is selected on the map, well data sourced from a third-party data provider populates SELECTED WELL DATA with the following data or portions thereof: API/UWI; Well/Lease Name; Operator; Status; County; State; Drill Type; Measured Depth (TD); Cumulative Oil; Cumulative Gas; First Production; Last Production; Spud Date; Reservoir; Longitude; Latitude; First 12, 24 and 60 months Barrels of Oil; First 12, 24 and 60 months MCF of Gas; Last 12 Barrels of Oil; Last 12 MCF of Gas. In addition, the ROI is displayed on a tag above the selected pin; ROI's for First 12, 24, 60 and Last 12 months of production are instantly calculated; and the Estimated Net Cash Flow is instantly calculated and displayed. An example of a window that includes a selected pin from the Digital Map portion and associated data displayed in the Selected Well Data is illustrated in FIG. 21.

In some embodiments and during the method 200, the system 10 instantly compares historic well production data sets by with in a specific radius of predetermined location(s) identified by LAT/LON or API Number. The historic well production data sets may include oil and gas prices, cost terms, taxes, status, drill type, measured depth, reservoir, date ranges and oil and gas production ranges. As such, the system 10 enables the user to filter and compare past production of similar or selected wells inclusive of prices, terms, taxes and more to create hypothetical scenarios with unlimited variables to set performance expectations. Activating Close-ology requires inputs by the user beginning with a location.

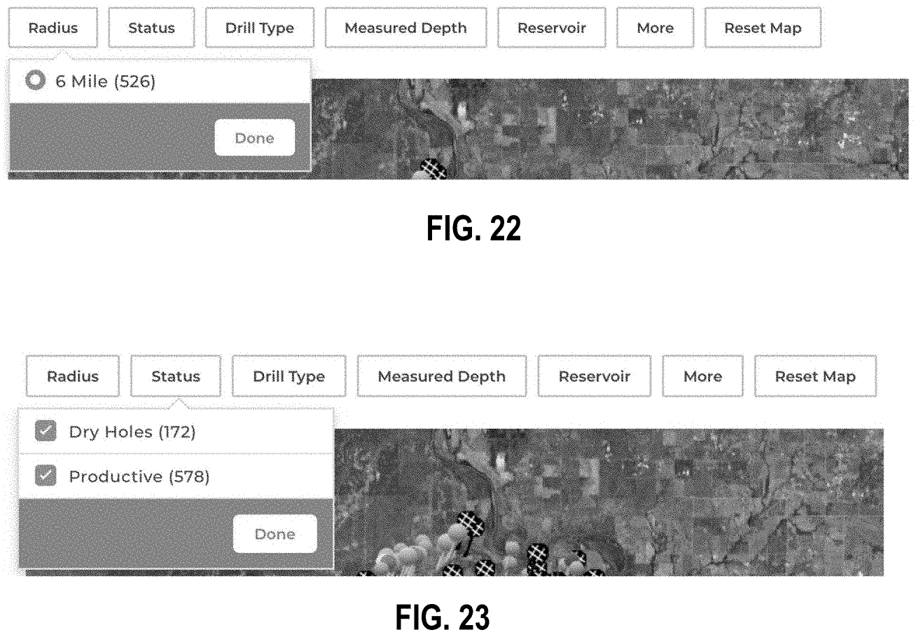

In some embodiments, the FIG. 22 is an illustration of a window or a portion of a window displayed on the GUI 15a during the step of filtering the data displayed on the PDP. Generally, when a filter is selected the selections are viewed in a drop-down box with scrolling functionality. Once a selection is made, the drop-down box disappears.

FIG. 23 is an illustration of a window or a portion of a window displayed on the GUI 15a during the step of filtering the data displayed on the PDP.

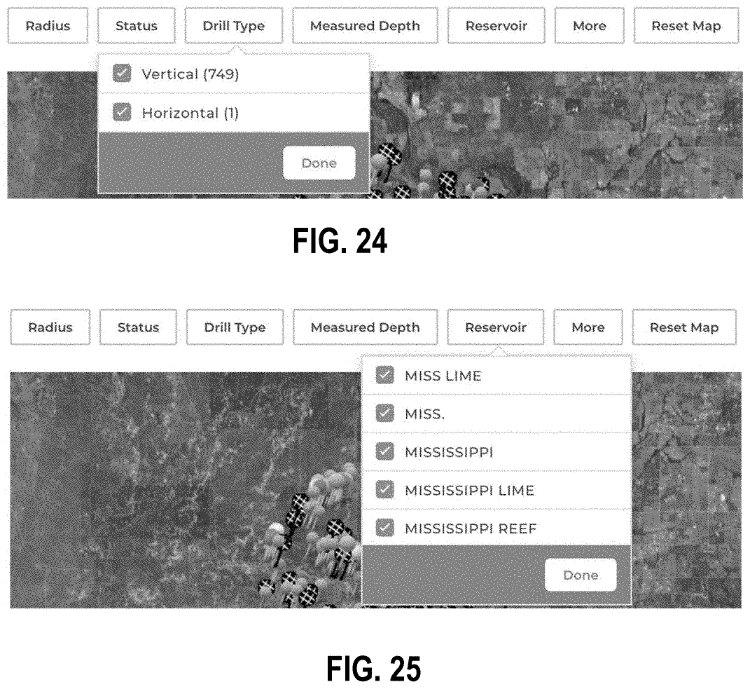

FIG. 24 is an illustration of a window or a portion of a window displayed on the GUI 15a during the step of filtering the data displayed on the PDP.

FIG. 25 is an illustration of a window or a portion of a window displayed on the GUI 15a during the step of filtering the data displayed on the PDP.

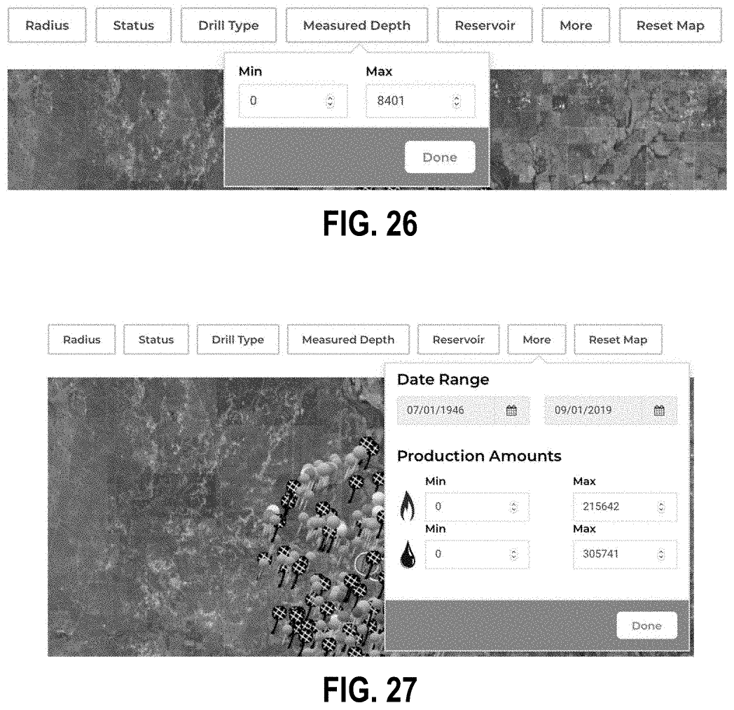

FIG. 26 is an illustration of a window or a portion of a window displayed on the GUI 15a during the step of filtering the data displayed on the PDP.

FIG. 27 is an illustration of a window or a portion of a window displayed on the GUI 15a during the step of filtering the data displayed on the PDP.

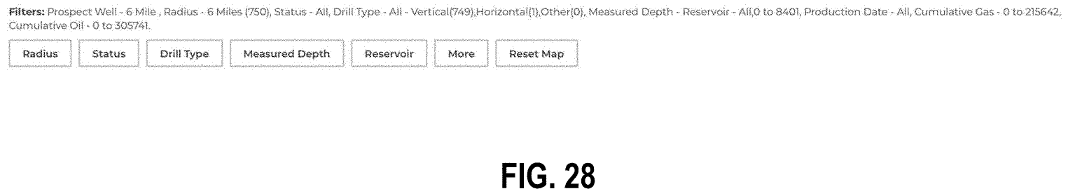

FIG. 28 is an illustration of a window or a portion of a window displayed on the GUI 15a during the step of filtering the data displayed on the PDP. As illustrated, a Filter trail displays the selected data parameters.

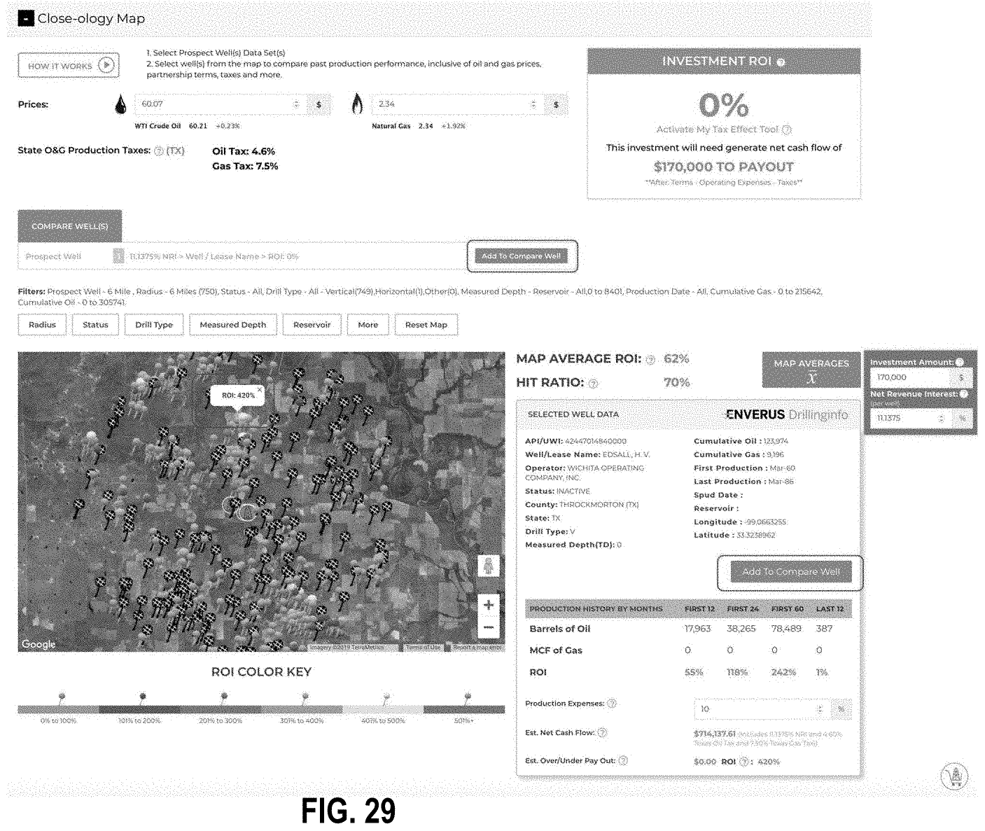

In some embodiments, the system 10 compares the PDP data. For example, the comparison may be between a prospect well and a well within the map of the Digital Map portion. FIG. 29 is an example of a window displayed during the step of comparing PDP data. In some embodiments, with a well selected (via selection of a pin or otherwise), the user then selects a selectable “Add to Compare Well” button that is displayed on the window.

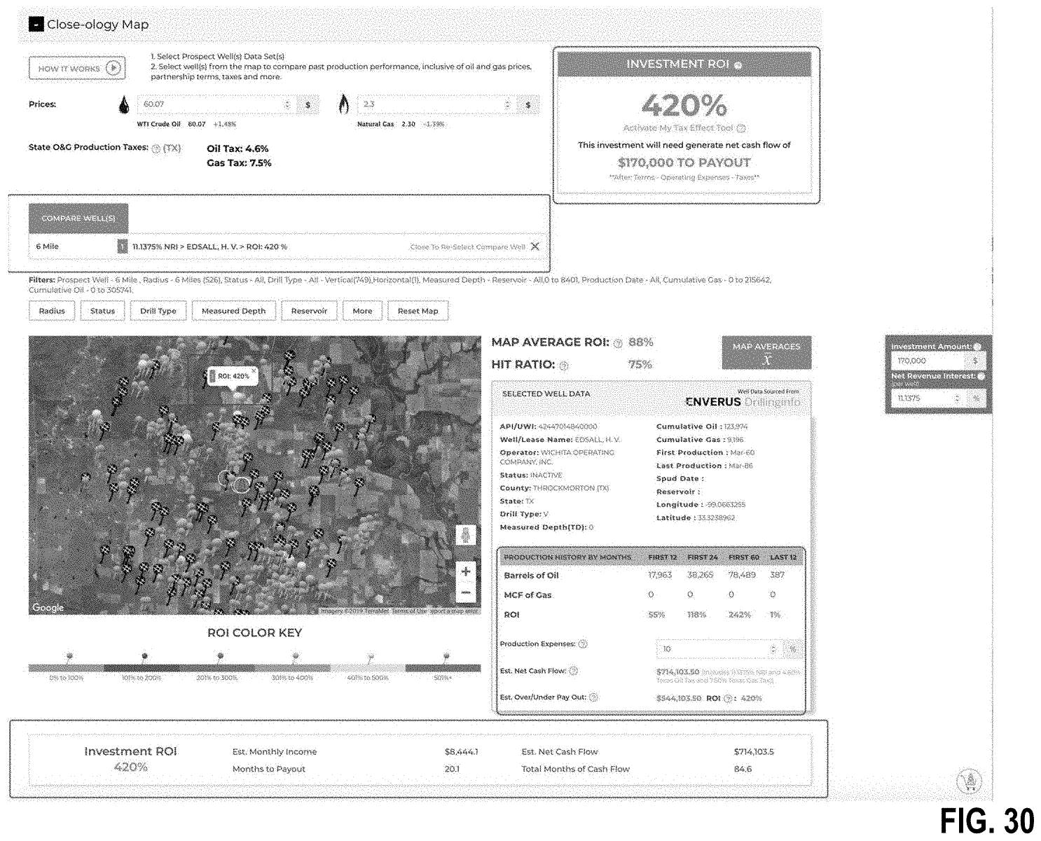

An example window displayed in response to the user selecting the “Add to Compare Well” button is illustrated in FIG. 30. As illustrated, when the “Add to Compare Well” button is selected, the ROI is displayed on a tag above the selected pin; the Compare Well(s) bar displays Radius, ROI, NRI %, Well Name; the Investment ROI box is activated; the Selected well potential ROI's by 12, 24, 60 and last 12 months of production are instantly calculated; a Snapshot of Cash Flow Simulator is displayed; an Estimated Net Cash Flow is calculated; an Estimated Over/Under Payout is calculated; and a Cash Flow Simulator is activated and instantly defaults the selected well production data.

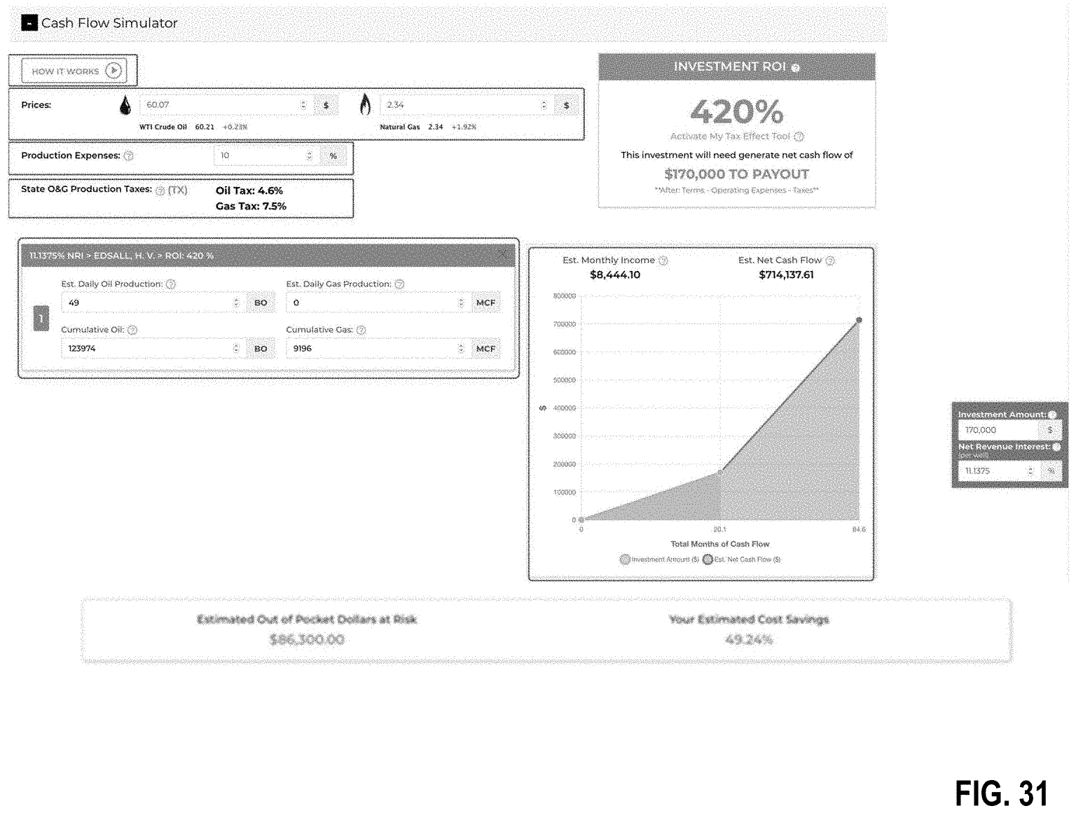

In one embodiment, the method 200 includes displaying a cash flow simulator. One example of a window that displays the cash flow simulator is illustrated in FIG. 31. Generally, when the Cash Flow Simulator is activated it instantly defaults to production data for the well selected on the Close-ology Map. For example, the production data includes any one or more of: Estimated Daily Oil Production; Estimated Daily Gas Production; Cumulative Oil; and Cumulative Gas. In some embodiments, the system 10 includes a Cash Flow Simulator: Video content placeholder. Here, the video content placeholder is illustrated as the “How it Works” button on the window. Generally, the system 10 also provides Oil and Gas Prices via a third-party data provider, with changing oil and gas prices effecting all ROI's, Estimated Net Cash Flow and Estimated Monthly Income. In some embodiments, the system 10 also displays the Production Expenses, with changing Production Expenses effecting all ROI's, Estimated Net Cash Flow and Estimated Monthly Income. In some embodiments, the system 10 also displays state taxes and accesses the data via a third-party data provider that may be one of the plurality of data sources 35. In some embodiments, a cash flow chart has a left vertical chart axis that depicts the Estimated Net Cash Flow while the bottom horizontal axis depicts the Total Months of Cash Flow. The system 10 can also display the Estimated Monthly Income; the Estimated Net Cash Flow; and the Total Months of Cash Flow on the window during the step of displaying the cash flow simulator.

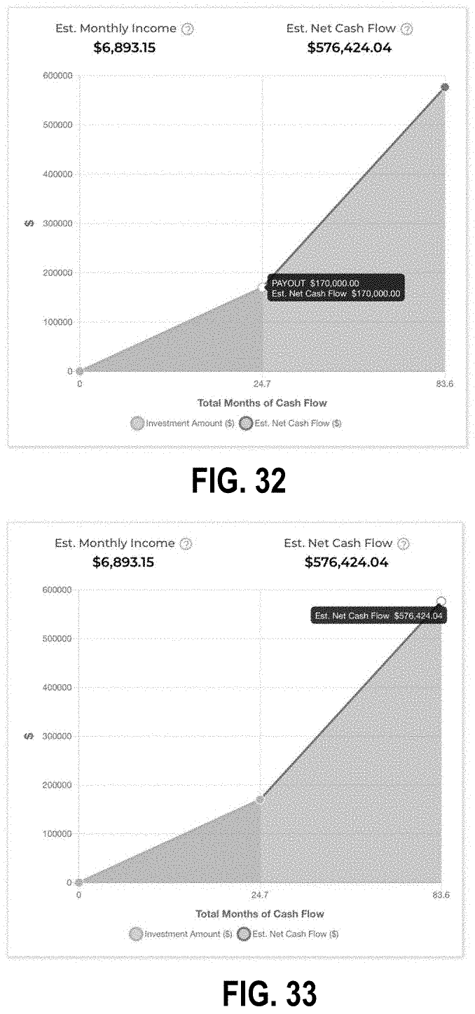

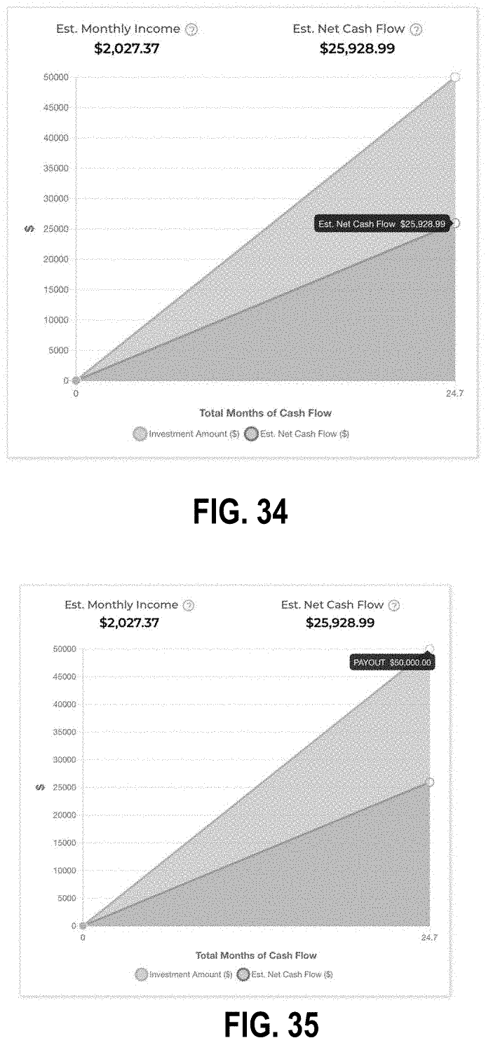

The cash flow chart illustrates the point at which the estimated net cash flow exceeds the investment amount. For example, and as illustrated in FIGS. 32 and 33, when the Estimated Net Cash Flow exceeds the Investment amount, then the chart is green halfway across and the second half is blue with a prompt above the Total Months to Payout and Total Months of Cash Flow with associated tags displaying: Payout (Investment Amount) and Estimated Net Cash Flow. Generally, tags for Estimated Net Cash Flow and Estimated Monthly Income appear when the cursor is dragged over the prompt. For example, and as illustrated in FIGS. 34 and 35, when the Estimated Net Cash Flow does not exceed the Investment amount, the chart is green all the way across and blue is overshadowed by the green with a prompt above the Total Months of Cash Flow with associated tags displaying: Payout (Investment Amount) and Estimated Net Cash Flow.

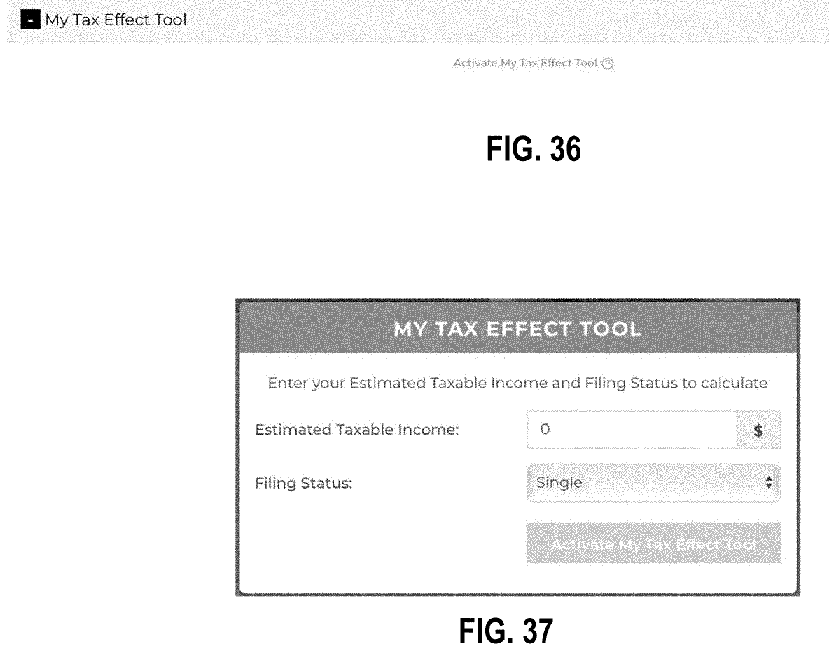

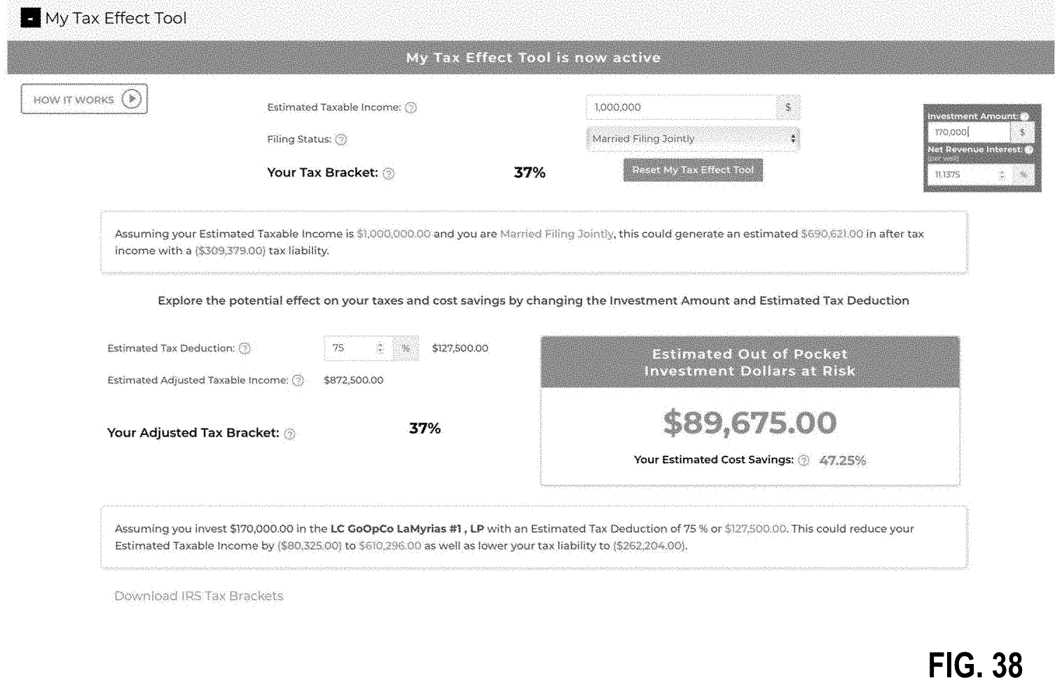

As noted above, the method 200 may include displaying a My Tax Effect Tool. Generally, the My Tax Effect Tool is a graphic illustration of the IRS tax and income brackets. Generally, the user selects a selectable “Activate My Tax Effect Tool” button that forms a portion of a window, an example embodiment of which is illustrated in FIG. 36. After selecting the selectable button, the system 10 displays a prompt box that prompts the user to enter Estimated Taxable Income and Filing Status. An example prompt box is illustrated in FIG. 37. After receiving the requested information, the system 10 displays the My Tax Effect Tool as illustrated in FIG. 38. Generally, using the two inputs, the tool expands and gives the user the ability to explore different scenarios inclusive of Investment Amount, Estimated Taxable Income, Filing Status and Estimated Tax Deduction.

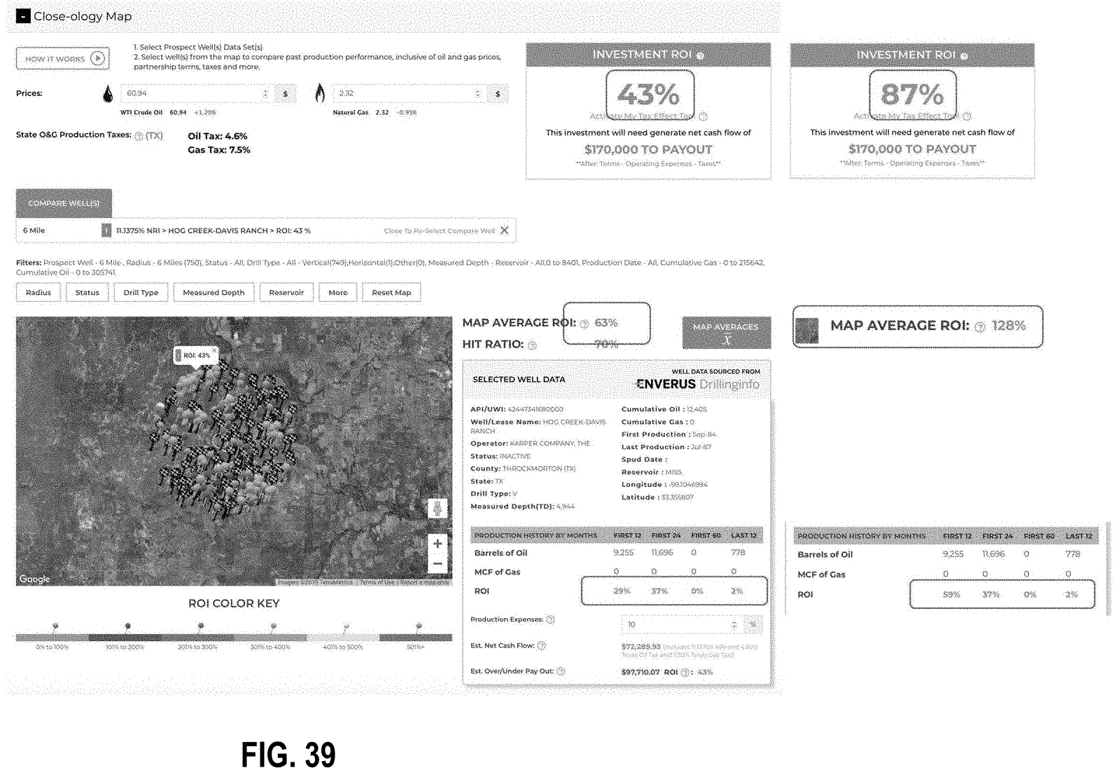

In some embodiments, when the My Tax Effect Tool is activated, all pins associated with Green ROI's displayed will turn to blue and display the My Tax Effect ROI, as illustrated in FIG. 39.

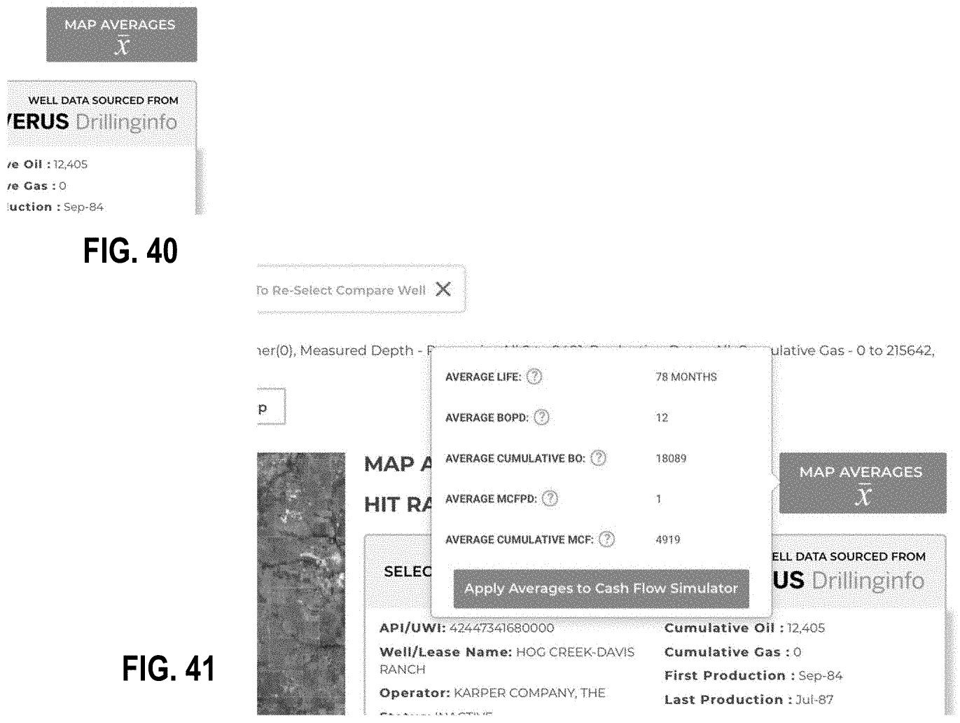

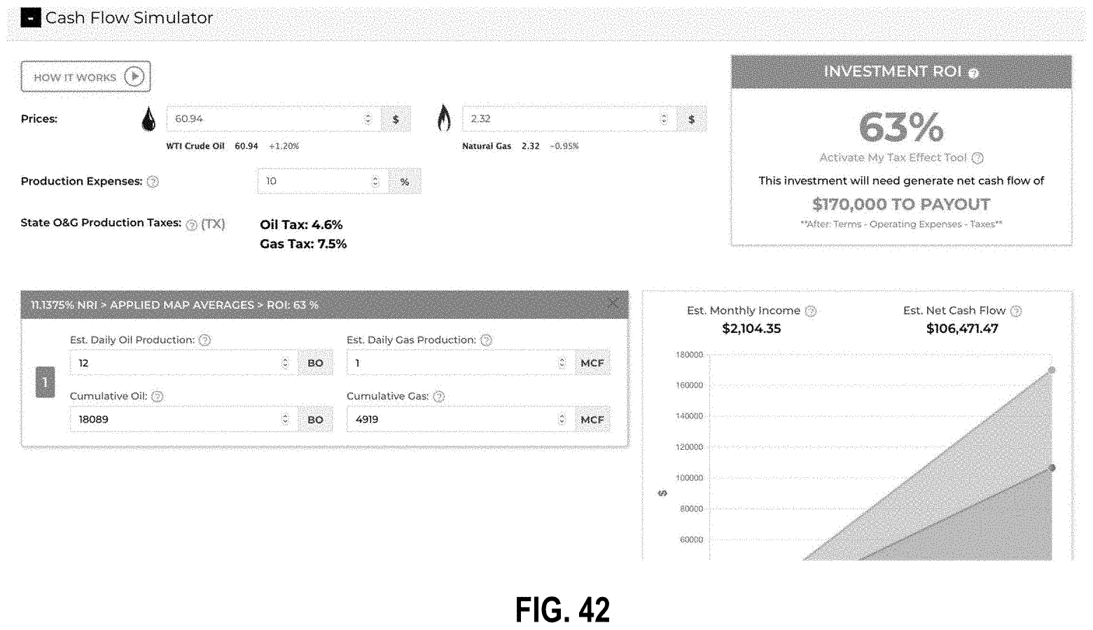

As noted above, the method 200 may include displaying One Click Map Averages. Generally, the map average is displayed after the user selects a selectable button “Map Averages” as illustrated in FIG. 40. Upon selection of the “Map Averages” button, another window is displayed as illustrated in FIG. 41. The One click map averages applies the filter results from the Close-ology Map to display: Average Life; Average BOPD; Average Cumulative BO; Average MCFPD; and Average Cumulative MCF. Generally, to apply the map averages to the Cash Flow Simulator, the user selects a selectable “Apply Averages to Cash Flow Simulator” button. The system 10 then displays the map average to the Cash Flow Simulator, as illustrated in FIG. 42.

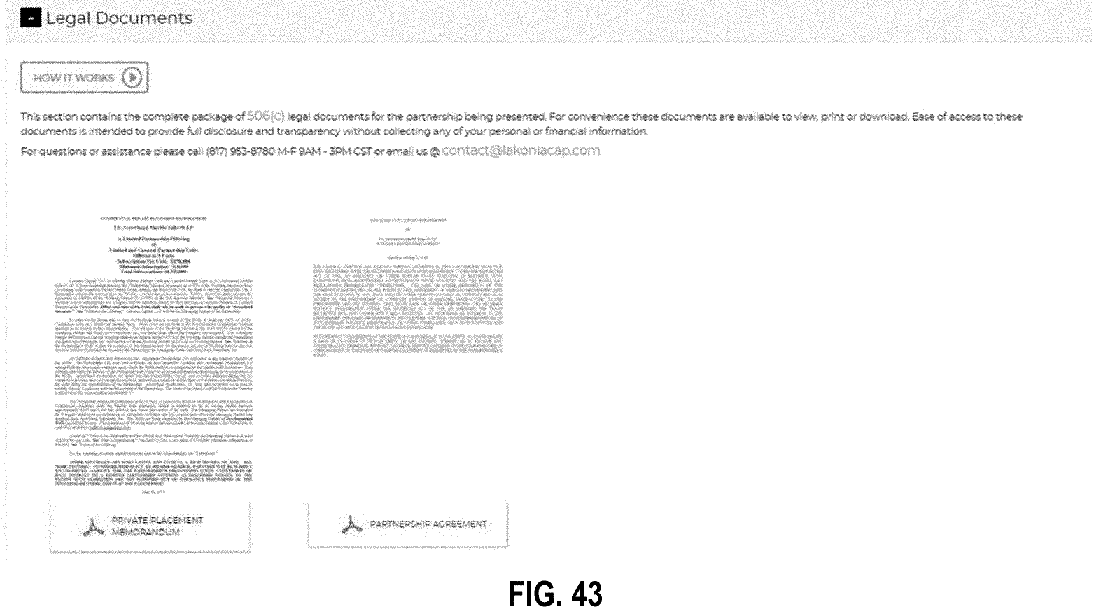

In some embodiments, the PDP may also include viewable legal documents associated with the prospect well or agreement. For example, and as illustrated in a window depicted in FIG. 43, the PDP may include links to pdfs or other relevant legal documents that are selectable and viewable.

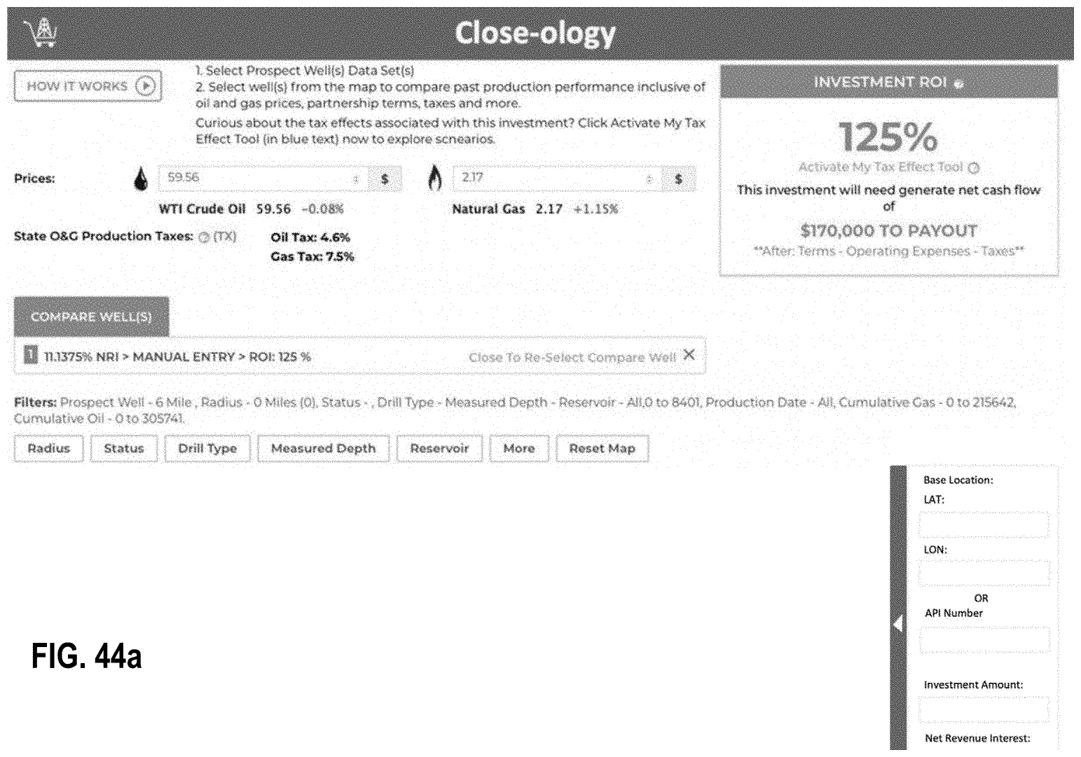

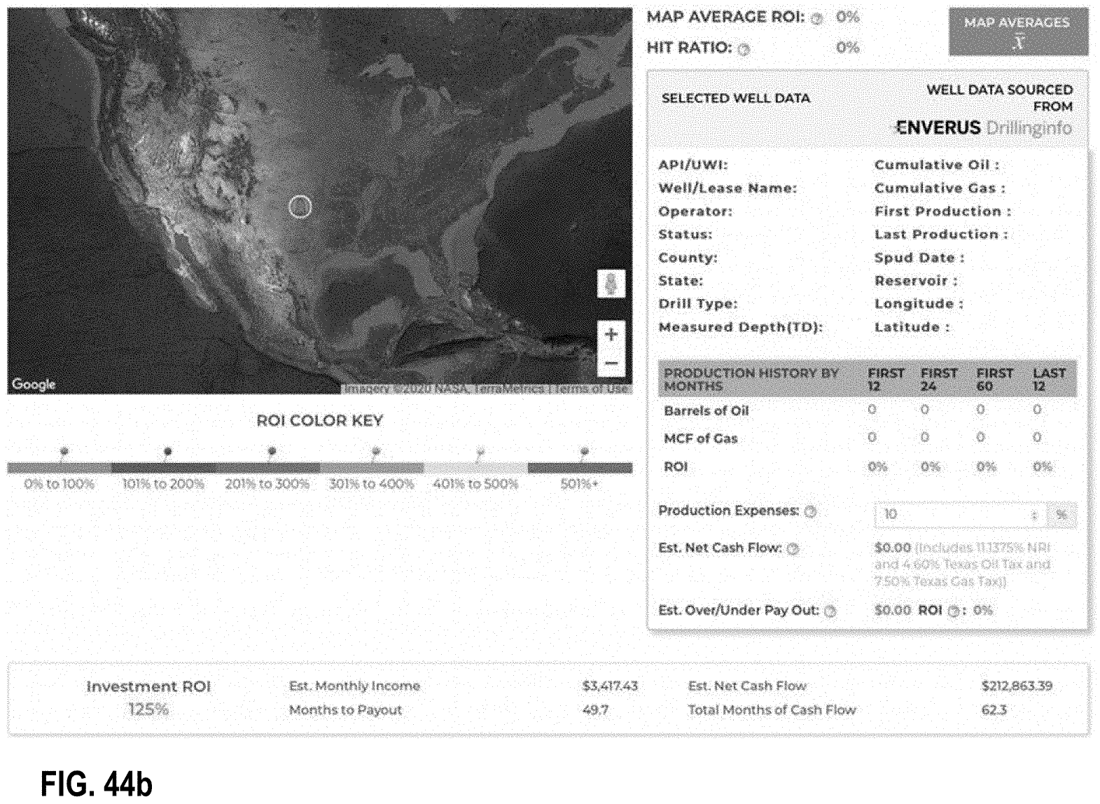

In some embodiments, the close-ology application can be a stand-alone application as illustrated in FIGS. 44a-44b.

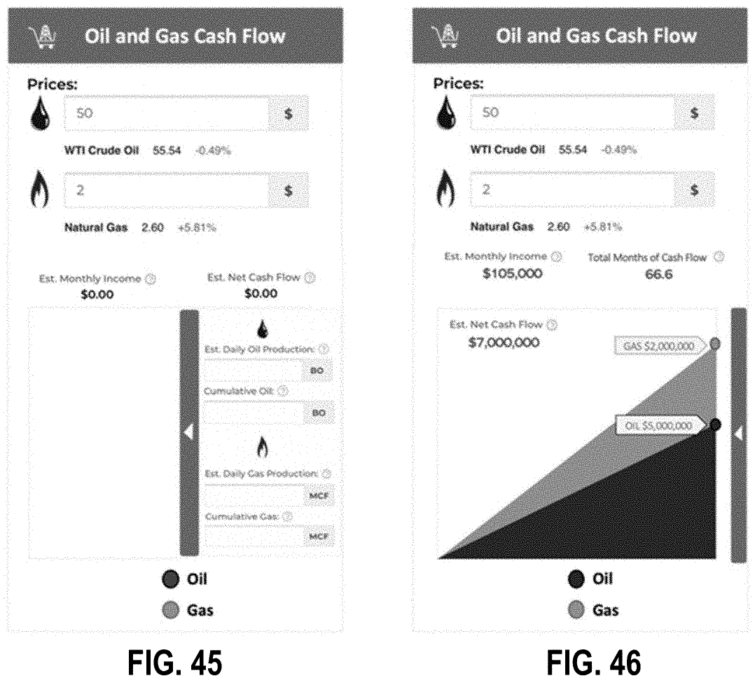

In some embodiments, an oil and gas cash flow application can be a stand-alone application as illustrated in FIGS. 45 and 46.

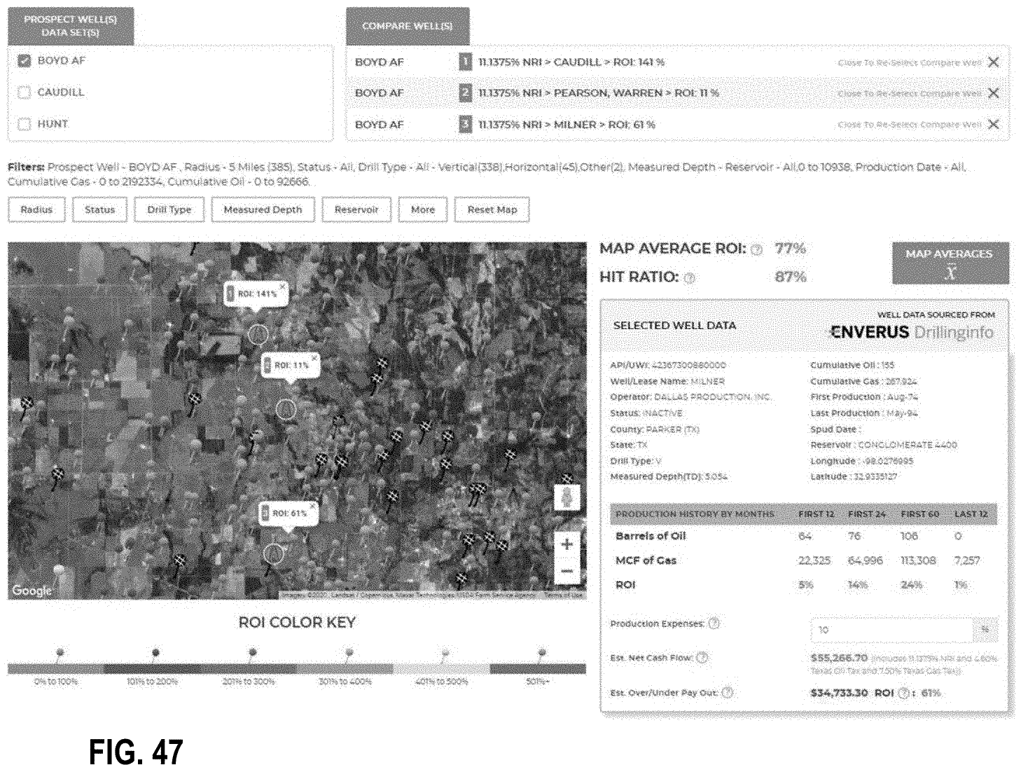

Another example of a window depicting the close-ology map when comparing PDP data is illustrated as FIG. 47. As illustrated, three prospect wells are associated with the potential agreement, and existing wells are illustrated relative to the prospect wells on the map using the pins. Three existing wells are also shown as selected to compare on the map, with the ROI associated with each of the existing wells illustrated above each pin.

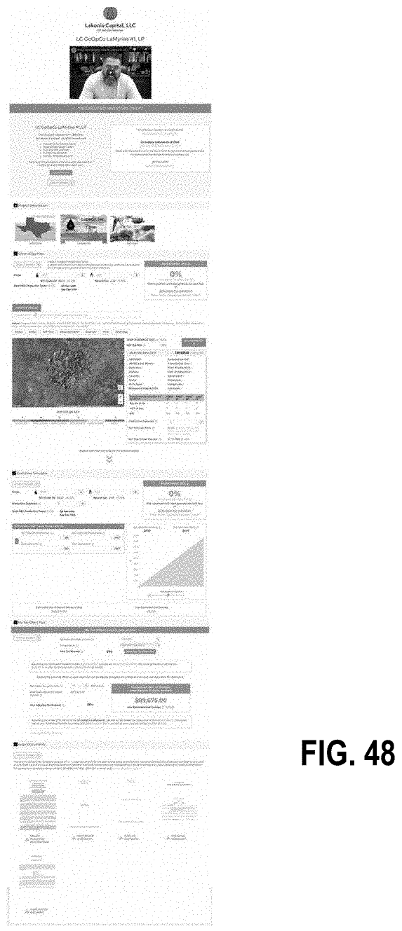

An example of the PDP is illustrated in FIG. 48. As illustrated and in some embodiments, the close-ology map portion, the project description, the cash flow simulator, the One Click Map, and the tax effect tool form one webpage, with the data entered in one portion being used throughout the remaining portions. In some embodiments, when calculating the ROI and comparing the prospect wells to the existing wells, the system 10 uses the details entered for the specific deal or agreement that is associated with the PDP. For example, the ROI is calculated based on the oil and gas prices, the terms of the prospect partnership associated with the PDP, the cost of the prospect partnership associated with the PDP, etc. As such, the Close-ology Map provides a comp system for existing wells using the partnership details associated with the prospect partnership or agreement.

In some embodiments, the system 10, or OWS, creates “the line” for oil and gas non-op working interest partnerships and joint ventures. In some embodiments, the system 10, or OWS constructs, markets, and distributes digital oil and gas partnerships or joint ventures. In some embodiments, the system 10, or OWS, is a sales tool to produce compelling presentations and properly guide expectations for issuers and investors. In some embodiments, the system 10, or OWS, is software that is a web-based efficient method of distribution for private placements and replaces inefficient paper-based marketing materials. In some embodiments, the system 10, or OWS, improves distribution and reach capabilities with a web-based point of purchase product. In some embodiments, the system 10, or OWS, creates a pricing and cost control tool to standardize pricing and provide proper due diligence of an oil and gas partnership offering working interest.

In some embodiments, PDP is a complete and compliant digital presentation for the purpose of distributing and marketing oil and gas partnerships, including Close-ology Map, Oil and Gas Cash Flow Simulator, My Tax Effect Tool and more. In some embodiments, the stand-alone Close-ology Map App instantly compares, to wells within a radius expressed in miles of hundreds or thousands, historic oil and gas well data inclusive of oil and gas prices, production taxes, investment amount, investment terms expressed as NRI % (Net Revenue Interest %), Status—Productive or Dry, Drill Type—Vertical, Horizontal, Other Drill, Measured Depth—Minimum to Maximum, Reservoir, Date Range, Production Amounts—Oil Minimum to Maximum, Gas Minimum to Maximum. In some embodiments, the stand-alone Oil and Gas Cash Flow Simulator App allows for a user to input oil and gas production data to explore hypothetical financial performance scenarios with oil and gas prices, daily and cumulative production of barrels of oil and mcf of gas.

Generally, the PDP lists details for at least one non-operated working interest partnership and joint venture. The PDP is the first complete and compliant digital presentation for the purpose of marketing, distributing, and managing oil and gas non-op working interest partnerships or joint ventures. Generally, the PDP is NOT a financial evaluation tool. The PDP is an organization of specific data necessary to make a fully informed decision when purchasing, pricing, or evaluating a non-op working interest oil and gas partnership or joint venture. The system 10 enables users to market directly to customers through electronic communication and social media outlets by housing and sharing strategically placed video content. The PDP software includes unique interactive functionality providing users the ability to explore unlimited hypothetical financial performance scenarios expressed as ROI % inclusive of user inputs.

In some embodiments, the Tax Effect Tool gives users the ability to explore the potential effect on their income tax by investing and receiving a tax deduction. Users input the amount of Estimated Taxable Income for the current year, Filing Status and Estimated Tax Deduction to access the IRS tax and income brackets and determine the difference in the user's net income after tax expressed as Estimated Out of Pocket Investment Dollars at Risk and Your Estimated Cost Savings %. Once the Tax Tool is activated ROI %'s throughout the PDP flip and change from green to blue by dragging the cursor over all displayed ROI's.

Conventional systems for managing documents and information relating to non-operated working interest partnership and joint venture are incapable of efficiently managing, tracking, and displaying all relevant information relating to a prospect well and existing wells. Often, with conventional systems, it was possible to “cherry-pick” key wells and use minimal data points to mislead prospect investors.

The system 10 provides additional transparency over conventional systems. Specifically, the system 10 provides convenient and instant access to current relevant information from independent sources of to present, inform, educate, and guide performance expectations. Moreover, the Close-ology Map of the system 10 is a digital map loaded with radius(es) of non-bias oil and gas well data with variables to identify and compare past oil and gas production inclusive of user inputs. Close-ology is interactive and instantly measures and compares all wells included in the data set with historic oil and gas production inclusive of oil and gas prices, investment terms, taxes and more to produce hypothetical ROI's for individual data points and complete data sets. In some embodiments, Law-of-Large numbers is the theory being implemented for users to establish performance expectations. One Click Map Averages guides user's performance expectations by instantly viewing the Average Life expressed in months, Average BOPD, Average Cumulative BO, Average MCFPD, Average Cumulative MCF of the oil and gas wells in the dataset inclusive of user inputs.

Conventional systems for managing documents and information relating to non-operated working interest partnership and joint venture are incapable of providing appropriate access to relevant documents associated with the prospect well. For example, security regulations required rooms of salespeople making out going phone calls in an effort to identify and verbally verify accredited investors. Once identified and verbally verified, paper offering materials are sent by mail carriers and the salesperson begins following up to complete the subscription process and satisfy payment.

The system 10 improves access by investors and owners/issuer over conventional systems. For example, the PDP complies with securities regulations and is the first unrestricted web-based point of purchase product for private placements providing educational video content created by the user presenting the partnership or joint venture with electronic subscription and funding functionality.

Conventional systems for managing documents and information relating to non-operated working interest partnership and joint venture are incapable of providing appropriate pricing control. Specifically, partnership pricing is primarily based on the financial requirements and desires of the Issuer. Unstandardized or covert pricing methods can lead to unrealistic or unachievable investment performance expectations.

The system 10, via the Close-ology map/application, allows for partnership pricing to be based on historic oil and gas production in the selected radius inclusive of oil and gas prices, partnership or joint venture terms expressed as NRI %, and Investment Amount. A standard method of pricing provides users the ability to instantly measure, compare and understand potential performance outcomes.

Conventionally, the aggregation of data relevant to a non-operated working interest partnership involved the use of paper maps with limited oil and gas well data, excel spreadsheets, PPM to find investment terms, static financial performance projections, and some sales-inspired hyperbole.

In some embodiments, the system 10 instantly renders information on wells within a defined radius(es), with the information inclusive of oil and gas prices, production taxes, investment amount, investment terms expressed as NRI % (Net Revenue Interest %), Status—Productive or Dry, Drill Type—Vertical, Horizontal, Other Drill, Measured Depth—Minimum to Maximum, Reservoir, Date Range, Production Amounts—Oil Minimum to Maximum, Gas Minimum to Maximum would be impossible without a computer and the OWS software and makes all of these functions faster. Specifically, the system 10 via the Close-ology Map function and/or PDP is the first complete digital presentation for the purpose of distributing and marketing oil and gas partnerships and includes Close-ology Maps that presents information on wells within a defined radius(es), which includes oil and gas well data direct from a credible third party data service with interactive functionality to instantly identify and compare historic well performance inclusive of oil and gas prices, production taxes, investment amount, investment terms expressed as NRI % (Net Revenue Interest %), Status—Productive or Dry, Drill Type—Vertical, Horizontal, Other Drill, Measured Depth—Minimum to Maximum, Reservoir, Date Range, Production Amounts—Oil Minimum to Maximum, Gas Minimum to Maximum. One Click Map Averages guides user's performance expectations by instantly viewing the Average Life expressed in months, Average BOPD, Average Cumulative BO, Average MCFPD, Average Cumulative MCF of the oil and gas wells in the dataset inclusive of user inputs.

Generally, the Close-ology Map's instantly displays hypothetical ROI's on wells within a defined radius(es), which includes hundreds or thousands of oil and gas wells inclusive of user inputs including oil and gas prices, production taxes, investment amount, investment terms expressed as NRI % (Net Revenue Interest %), Status—Productive or Dry, Drill Type—Vertical, Horizontal, Other Drill, Measured Depth—Minimum to Maximum, Reservoir, Date Range, Production Amounts—Oil Minimum to Maximum, Gas Minimum to Maximum. The One Click Map Averages guides user's performance expectations by instantly viewing the Average Life expressed in months, Average BOPD, Average Cumulative BO, Average MCFPD, Average Cumulative MCF of the oil and gas wells in the dataset inclusive of user inputs. The Cash Flow Simulator allows users to compare and create cash flow scenarios by clicking on oil and gas well points from the Close-ology Map or Manual Entries or Applied Map Averages. The Tax Effect Tool instantly applies user's entered input of Estimated Annual Income, Filing Status and Tax Deduction Amount into the IRS tax and income brackets to produce hypothetical Tax Equivalent ROI's. Once the Tax Effect Tool is active, if the cursor is dragged across any displayed ROI, the Tax Equivalent ROI will be displayed as the green ROI flips to blue.

In several example embodiments, execution of one or more steps of the method 200 enables a user (or other personnel) to forgo checking several of the plurality of data sources 35. Instead, in several example embodiments, execution of one or more steps of the method 200 results in the continuous and automatic updating and comparison of existing data for existing wells to the prospect wells associated with a prospect agreement. As such, the displays on windows and included selectable buttons improves the functioning of the computer, such as the computer 15, on which the windows are displayed. The processing and comparing of data is performed on a computer remote from the computer, such as the computer 30. As such, the system 10 eliminates the need for the computer 15 to search, compute, compare, etc. the PDP data. This, in turn, reduces the processing load compared to the computer 15 needing to present login screens and sub screens and/or file folders and receiving input commands relating to the searching. Reducing the processing load of the computer 15 generally improves the performance of the computer 15 such that the available memory of the computer 15 is increased, the processing capacity of the computer 15 is increased therefore making the computer 15 operate more efficiently, and the processing speed of the computer 15 is increased. Thus, the system 10 improves the functioning of the computer 15 itself. That is, the system 10 results in specific improvements in computer capabilities (i.e., reduction of required memory and reduction of processing load).

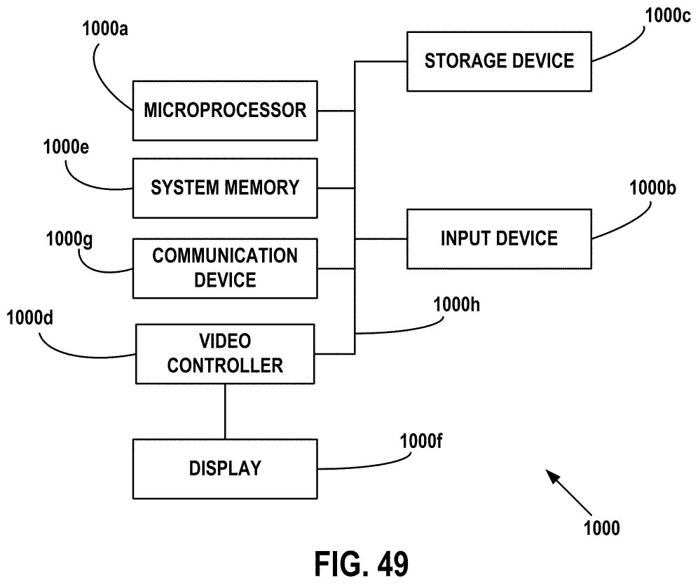

In an example embodiment, as illustrated in FIG. 49 with continuing reference to FIGS. 1-48, an illustrative node 1000 for implementing one or more of the example embodiments described above and/or illustrated in FIGS. 1-48 is depicted. The node 1000 includes a microprocessor 1000a, an input device 1000b, a storage device 1000c, a video controller 1000d, a system memory 1000e, a display 1000f, and a communication device 1000g all interconnected by one or more buses 1000h. In several example embodiments, the storage device 1000c may include a floppy drive, hard drive, CD-ROM, optical drive, any other form of storage device and/or any combination thereof. In several example embodiments, the storage device 1000c may include, and/or be capable of receiving, a floppy disk, CD-ROM, DVD-ROM, or any other form of computer-readable medium that may contain executable instructions. In several example embodiments, the communication device 1000g may include a modem, network card, or any other device to enable the node to communicate with other nodes. In several example embodiments, any node represents a plurality of interconnected (whether by intranet or Internet) computer systems, including without limitation, personal computers, mainframes, PDAs, smartphones, and cell phones.

In several example embodiments, one or more of the components of the systems described above and/or illustrated in FIGS. 1-48 include at least the node 1000 and/or components thereof, and/or one or more nodes that are substantially similar to the node 1000 and/or components thereof. In several example embodiments, one or more of the above-described components of the node 1000, the system 10, and/or the example embodiments described above and/or illustrated in FIGS. 1-48 include respective pluralities of same components.

In several example embodiments, one or more of the applications, systems, and application programs described above and/or illustrated in FIGS. 1-48 include a computer program that includes a plurality of instructions, data, and/or any combination thereof; an application written in, for example, Arena, Hypertext Markup Language (HTML), Cascading Style Sheets (CSS), JavaScript, Extensible Markup Language (XML), asynchronous JavaScript and XML (Ajax), and/or any combination thereof; a web-based application written in, for example, Java or Adobe Flex, which in several example embodiments pulls real-time information from one or more servers, automatically refreshing with latest information at a predetermined time increment; or any combination thereof.

In several example embodiments, a computer system typically includes at least hardware capable of executing machine readable instructions, as well as the software for executing acts (typically machine-readable instructions) that produce a desired result. In several example embodiments, a computer system may include hybrids of hardware and software, as well as computer sub-systems.

In several example embodiments, hardware generally includes at least processor-capable platforms, such as client-machines (also known as personal computers or servers), and hand-held processing devices (such as smart phones, tablet computers, personal digital assistants, or personal computing devices (PCDs), for example). In several example embodiments, hardware may include any physical device that is capable of storing machine-readable instructions, such as memory or other data storage devices. In several example embodiments, other forms of hardware include hardware sub-systems, including transfer devices such as modems, modem cards, ports, and port cards, for example.

In several example embodiments, software includes any machine code stored in any memory medium, such as RAM or ROM, and machine code stored on other devices (such as floppy disks, flash memory, or a CD ROM, for example). In several example embodiments, software may include source or object code. In several example embodiments, software encompasses any set of instructions capable of being executed on a node such as, for example, on a client machine or server.

In several example embodiments, combinations of software and hardware could also be used for providing enhanced functionality and performance for certain embodiments of the present disclosure. In an example embodiment, software functions may be directly manufactured into a silicon chip. Accordingly, it should be understood that combinations of hardware and software are also included within the definition of a computer system and are thus envisioned by the present disclosure as possible equivalent structures and equivalent methods.

In several example embodiments, computer readable mediums include, for example, passive data storage, such as a random-access memory (RAM) as well as semi-permanent data storage such as a compact disk read only memory (CD-ROM). One or more example embodiments of the present disclosure may be embodied in the RAM of a computer to transform a standard computer into a new specific computing machine. In several example embodiments, data structures are defined organizations of data that may enable an embodiment of the present disclosure. In an example embodiment, a data structure may provide an organization of data or an organization of executable code.

In several example embodiments, any networks and/or one or more portions thereof may be designed to work on any specific architecture. In an example embodiment, one or more portions of any networks may be executed on a single computer, local area networks, client-server networks, wide area networks, internets, hand-held and other portable and wireless devices and networks.

In several example embodiments, a database may be any standard or proprietary database software. In several example embodiments, the database may have fields, records, data, and other database elements that may be associated through database specific software. In several example embodiments, data may be mapped. In several example embodiments, mapping is the process of associating one data entry with another data entry. In an example embodiment, the data contained in the location of a character file can be mapped to a field in a second table. In several example embodiments, the physical location of the database is not limiting, and the database may be distributed. In an example embodiment, the database may exist remotely from the server, and run on a separate platform. In an example embodiment, the database may be accessible across the Internet. In several example embodiments, more than one database may be implemented.

In several example embodiments, a plurality of instructions stored on a computer readable medium may be executed by one or more processors to cause the one or more processors to carry out or implement in whole or in part the above-described operation of each of the above-described example embodiments of the system, the method, and/or any combination thereof. In several example embodiments, such a processor may include one or more of the microprocessor 1000a, any processor(s) that are part of the components of the system, and/or any combination thereof, and such a computer readable medium may be distributed among one or more components of the system. In several example embodiments, such a processor may execute the plurality of instructions in connection with a virtual computer system. In several example embodiments, such a plurality of instructions may communicate directly with the one or more processors, and/or may interact with one or more operating systems, middleware, firmware, other applications, and/or any combination thereof, to cause the one or more processors to execute the instructions.

The present disclosure introduces a method according to one or more aspects of the present disclosure.

The present disclosure also introduces a system according to one or more aspects of the present disclosure.

The present disclosure also introduces an apparatus according to one or more aspects of the present disclosure.

The present disclosure also introduces a non-transitory computer readable medium according to one or more aspects of the present disclosure.

It is understood that variations may be made in the foregoing without departing from the scope of the disclosure. Furthermore, the elements and teachings of the various illustrative example embodiments may be combined in whole or in part in some or all of the illustrative example embodiments. In addition, one or more of the elements and teachings of the various illustrative example embodiments may be omitted, at least in part, and/or combined, at least in part, with one or more of the other elements and teachings of the various illustrative embodiments.

Any spatial references such as, for example, “upper,” “lower,” “above,” “below,” “between,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” “front-to-back,” etc., are for the purpose of illustration only and do not limit the specific orientation or location of the structure described above.

As used herein, the term “substantially” means that a numerical amount is within about 20 percent, preferably within about 10 percent, and more preferably within about 5 percent of a stated value. In a preferred embodiment, these terms refer to amounts within about 1 percent, within about 0.5 percent, or even within about 0.1 percent, of a stated value.

The phrase “at least one of A and B” should be understood to mean “A, B, or both A and B.” The phrase “one or more of the following: A, B, and C” should be understood to mean “A, B, C, A and B, B and C, A and C, or all three of A, B, and C.” The phrase “one or more of A, B, and C” should be understood to mean “A, B, C, A and B, B and C, A and C, or all three of A, B, and C.”

In several example embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several example embodiments have been described in detail above, the embodiments described are examples only and are not limiting, and those skilled in the art will readily appreciate that many other modifications, changes, and/or substitutions are possible in the example embodiments without materially departing from the novel teachings and advantages of the present disclosure. Accordingly, all such modifications, changes, and/or substitutions are intended to be included within the scope of this disclosure as defined in the following claims. In the claims, means-plus-function clauses are intended to cover the structures described herein as performing the recited function and not only structural equivalents, but also equivalent structures. Moreover, it is the express intention of the applicant not to invoke 35 U.S.C. § 112(f) for any limitations of any of the claims herein, except for those in which the claim expressly uses the word “means” together with an associated function.

What is claimed is:

1. A method according to one or more aspects of the present disclosure.

2. A system according to one or more aspects of the present disclosure.

3. An apparatus according to one or more aspects of the present disclosure.
